(19) United States
(12) Patent Application Publication
(10) Pub. No.: US 2026/0285717 A1
(43) Pub. Date: Sep. 24, 2026

(54) METHOD FOR METAL ION REMOVAL FROM METAL-CONTAINING SOLUTION USING FLUIDIZED BED HOMOGENEOUS CRYSTALLIZATION

(71) Applicants: TAIWAN SEMICONDUCTOR MANUFACTURING COMPANY, LTD., Hsinchu (TW); NATIONAL CHUNGHSING UNIVERSITY, Taichung City (TW)

(72) Inventors: Shang Hsing WU, Taichung City (TW); Ming-Chun LU, Taichung City (TW); Hui-Hsin TSENG, Taichung City (TW); Chung-Hung LEE, Changhua County (TW); Yu-Pin LO, Taichung City (TW); Po-Yang LU, Taichung City (TW)

(73) Assignees: TAIWAN SEMICONDUCTOR MANUFACTURING COMPANY, LTD., Hsinchu (TW); NATIONAL CHUNGHSING UNIVERSITY, Taichung City (TW)

(21) Appl. No.: 19/274,353

(22) Filed: Jul. 18, 2025

Related U.S. Application Data
(60) Provisional application No. 63/775,137, filed on Mar. 20, 2025.

(51) Int. Cl. C02F 1/66; B01D 9/00; C02F 1/00; C02F 1/02; C02F 1/52; C02F 101/20; C02F 103/34; C22B 15/00; C25D 21/16

(52) U.S. Cl. CPC C02F 1/66; B01D 9/0063; C02F 1/008; C02F 1/02; C22B 15/0086; C25D 21/16; B01D 2009/0086; C02F 2001/5218; C02F 2101/20; C02F 2103/346; C02F 2209/06; C02F 2301/046; C02F 2301/08

(57) ABSTRACT

A method includes providing an aqueous solution comprising one or more dissolved metal ions; partially neutralizing the aqueous solution by adding a first alkaline agent to adjust a pH of the aqueous solution toward a first target range; after partially neutralizing the aqueous solution, introducing the aqueous solution into a crystallization chamber; introducing a second alkaline agent into the crystallization chamber; recirculating the aqueous solution within the crystallization chamber; inducing a crystallization of metal-based solids from the aqueous solution within the crystallization chamber.

### BACKGROUND

Semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing are needed.

In the course of IC evolution, functional density (i.e., the number of interconnected devices per chip area) has generally increased while geometry size (i.e., the smallest component (or line) that can be created using a fabrication process) has decreased. This scaling down process generally provides benefits by increasing production efficiency and lowering associated costs. Such scaling-down also produces a relatively high power dissipation value, which may be addressed by using low power dissipation devices such as complementary metal-oxide-semiconductor (CMOS) devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a block diagram of a fabrication facility in accordance with some embodiments of the present disclosure.

FIG. 1B is a schematic diagram showing an electroplating apparatus, in accordance with some embodiments of the present disclosure.

FIGS. 2A-2D are block diagrams of a fabrication facility for processing metal-containing waste solutions, respectively, in accordance with some embodiments of the present disclosure.

FIG. 3A illustrates a reactor used in the fluidized bed homogeneous crystallization technology, in accordance with some embodiments of the present disclosure.

FIG. 3B illustrates a volatile organic compound (VOC) exhaust system with a heat exchanger, configured to heat the metal-containing waste solution and to dry the sludge formed from the metal-containing waste solution, in accordance with some embodiments of the present disclosure.

FIG. 4A shows a scatter plot illustrating the effect of different inlet flow rates on metal ion removal and crystallization efficiency, in accordance with some embodiments of the present disclosure.

FIG. 4B illustrates a dual-axis line and bar chart showing metal ion removal and crystallization efficiency over time during continuous reactor operation, in accordance with some embodiments of the present disclosure.

FIG. 4C shows a bar chart illustrating the effect of different metal ion concentrations on total removal efficiency and crystallization ratio in a fluidized bed crystallization system, in accordance with some embodiments of the present disclosure.

FIG. 4D a shows stacked bar chart comparing the particle size distribution of crystallized solids at different metal concentrate, in accordance with some embodiments of the present disclosure.

FIG. 4E shows a line chart illustrating a solubility of metal-containing waste solutions as a function of temperature, indicating higher solubility at elevated temperatures, in accordance with some embodiments of the present disclosure.

FIG. 5 illustrates a schematic perspective view of example Complementary Field-Effect Transistors (CFETs) in accordance with some embodiments.

FIGS. 6A-6F are schematic views of intermediate stages in the manufacturing of CFETs in accordance with some embodiments.

FIG. 7 is a flowchart of a method of processing metal-containing waste solutions, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, “around,” “about,” “approximately,” or “substantially” may generally mean within 20 percent, or within 10 percent, or within 5 percent of a given value or range. Numerical quantities given herein are approximate, meaning that the term “around,” “about,” “approximately,” or “substantially” can be inferred if not expressly stated. One skilled in the art will realize, however, that the values or ranges recited throughout the description are merely examples, and may be reduced or varied with the down-scaling of the integrated circuits.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In some embodiments, metal-containing wastewater generated after electroplating at fabrication facility is treated through chemical precipitation to form sludge. However, this method may generate excessive sludge, require high chemical usage, offer low copper recovery, and poses environmental risks. Therefore, the present disclosure introduces a fluidized bed homogeneous crystallization (FBHC) technology, which continuously treats metal-containing (e.g., copper-containing) waste solution by inducing the controlled nucleation and growth of metal-based (e.g., copper-based) crystals within a fluidized environment. The FBHC technique can allow fine-tuned pH control and supersaturation management, enabling metal ions like Cu²⁺ to crystallize as high-purity, low-moisture solids that can be collected and reused. The FBHC technique can minimize sludge generation, reduce the need for chelating agents, and improve the recovery rate of copper in a reusable form. Additionally, the continuous-flow operation can enhances treatment efficiency, scalability, and environmental compliance, making it suitable for integration into high-throughput industrial systems.

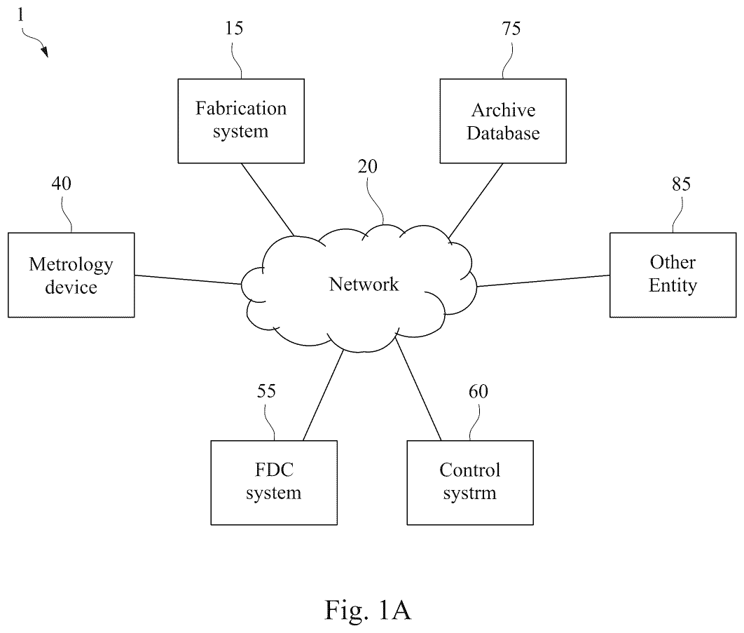

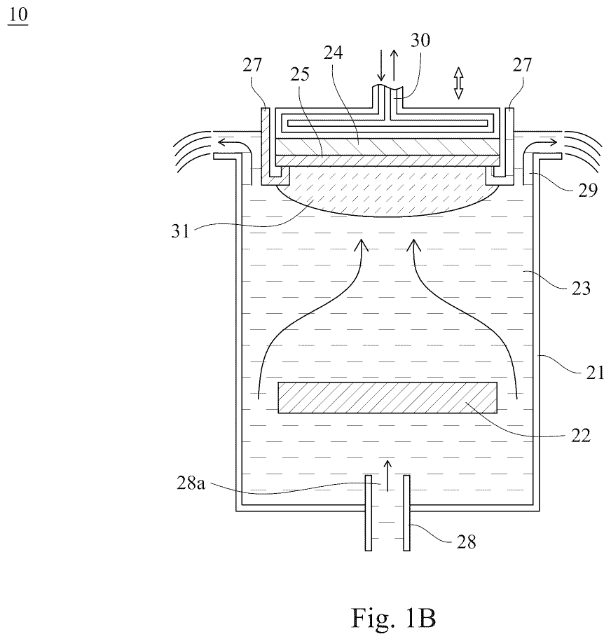

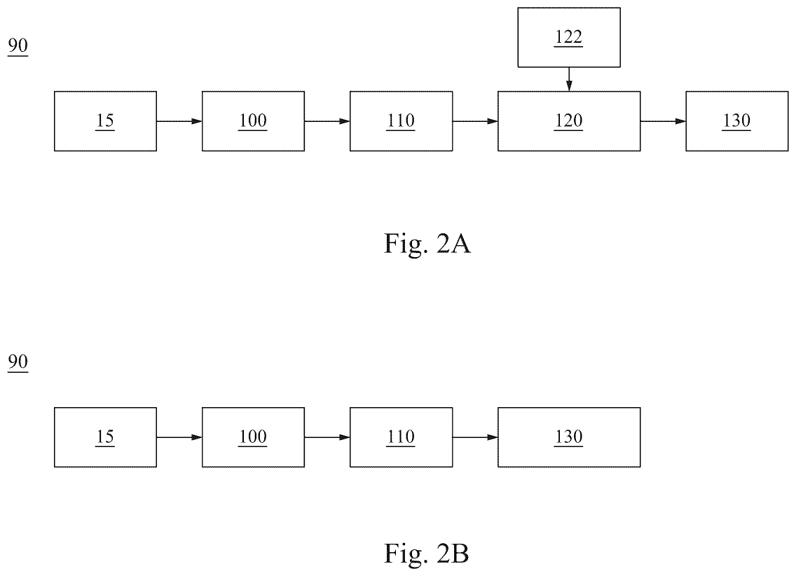

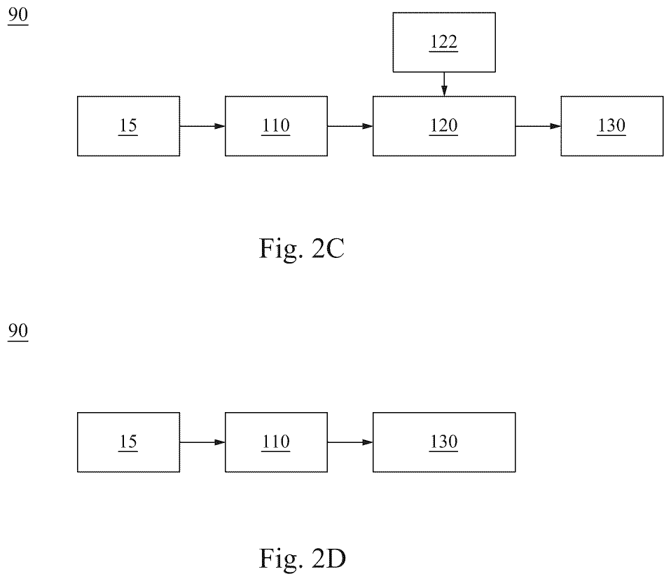

Reference is made to FIG. 1A. FIG. 1A is a block diagram of a fabrication facility in accordance with some embodiments of the present disclosure. The fabrication facility 1 implements integrated circuit manufacturing processes to fabricate integrated circuit devices. For example, the fabrication facility 1 may implement semiconductor manufacturing processes that fabricate semiconductor wafers. It should be noted that, in FIG. 1A, the fabrication facility 1 has been simplified for the sake of clarity to better understand the concepts of the present disclosure. Additional features can be added in the fabrication facility 1, and some of the features described below can be replaced or eliminated in other embodiments of the fabrication facility 1. The fabrication facility 1 may include more than one of each of the entities. In some embodiments, and may further include other entities not illustrated in the depicted embodiment. In some embodiments, the fabrication facility 1 can include a network 20 that enables various entities (a fabrication system 15 (e.g., electroplating apparatus 10 shown in FIG. 1B and waste treatment system 90 shown in FIGS. 2A-2D), a metrology device 40, a fault detection and classification (FDC) system 55, a control system 60, an archive data base 75, and another entity 85) to communicate with one another. The network 20 may be a single network or a variety of different networks, such as an intranet, the Internet, another network, or a combination thereof. The network 20 may include wired communication channels, wireless communication channels, or a combination thereof.

Reference is made to FIG. 1B. FIG. 1B is a schematic diagram showing an electroplating apparatus 10, in accordance with some embodiments of the present disclosure. The electroplating apparatus 10 can be part of the fabrication system 15 within the fabrication facility 1. The electroplating apparatus 10 can be used to deposit metal films (e.g., copper) onto semiconductor substrate 24 during integrated circuit manufacturing. During the electroplating process, the apparatus generates metal-containing waste solution, which includes residual metal ions (e.g., Cu²⁺) from the electrolyte that are not fully consumed in the plating reaction. This metal-containing waste solution can be directed to a treatment system, such as that illustrated in FIGS. 2A-2D, where metal ions are removed through processes including electroplating, crystallization, and chemical precipitation, thereby reducing metal content and enabling further reuse or safe disposal of the treated effluent. In some embodiments, the metal-containing waste solution also can be interchangeable referred to as a metal-containing aqueous solution or a metal-laden aqueous solution.

In FIG. 1B, the electroplating apparatus 10 in accordance with the disclosure for forming a metal film such as copper film applicable in integrated circuit (IC) fabrication is illustrated. The electroplating apparatus of the disclosure can be further modified by those skilled in the art and is not limited to the electroplating apparatus 10 in FIG. 1B. The electroplating apparatus 10 includes a plating tank 21, an anode 22, an electrolyte 23, a substrate holder 26 for holding a semiconductor substrate 24, a contact electrode 27, an electrolyte inlet 28 having an opening end 28a, and an electrolyte outlet 29. The electrolyte 23 is introduced from the electrolyte inlet tube 28 into the plating tank 21, and is discharged from the electrolyte outlet 29 by overflowing. The anode 22 can be soluble or insoluble and is disposed in the lower part of the electrolyte 23, and the semiconductor substrate 24 fixed to the substrate holder 26 is disposed at an upper part opposite to the anode 22. Moreover, a conductive layer 25 is deposited on the semiconductor substrate 24 as a seed layer. By disposing the semiconductor substrate 24 at an upper part of the plating tank 21, the semiconductor substrate 24 can be easily moved in and out of the plating tank 21, whereby the electroplating is performed.

In the present disclosure, a heater 30 independent to the plating tank 21 is disposed in the substrate holder 26 to generate and conduct heat to the semiconductor substrate 24. The heater 30 can be a heat exchange pipe containing thermal oil capable of heat exchange, as shown in FIG. 1B, or the other heating element such as an electrothermal coil.

In some embodiments, the electrolyte 23 can be provided form a storage tank (not shown) at a first temperature near the cleanroom temperature, about 25° C. or below, and the electroplating is then performed at the first temperature. In the disclosure, the heater 30 is then activated to generate and conduct heat to the semiconductor substrate 24 as well as the conductive layer 25 thereon to elevate the temperature of a portion of the electrolyte 23 (shown as a region 31) adjacent the conductive layer 25 to a second temperature higher than the first temperature of the other portion of the electrolyte 23. The metal electroplating is then performed through reacting the portion of electrolyte in the region 31 having a higher temperature with the conductive layer 25. Thus a metal film with improved electroplating performance such as better gap filling ability, better film uniformity and better film quality can be thus formed.

Reference is made to FIG. 2A. FIG. 2A is block diagrams of a waste treatment system 90 in the fabrication facility 1 for processing metal-containing waste solutions, respectively, in accordance with some embodiments of the present disclosure. As shown in FIG. 2A, the waste treatment system 90 can include an electroplating system 100 for initial metal removal, the fluidized bed homogeneous crystallization (FBHC) system 110 for further metal recovery, a wastewater treatment system 120 for chemical processing of residual metal ions, and a discharge system 130 for directing the treated waste solution to drainage.

In accordance with some embodiments of the present disclosure, the metal-containing waste solution (e.g., a copper sulfate solution) generated by the fabrication system 15 (e.g., electroplating apparatus 10) can be directed into an electroplating system 100 as an initial stage for metal removal. This metal-containing waste solution can include residual metal ions (e.g., Cu²⁺) that remain unconsumed after the plating process and must be treated before discharge or further reuse. The electroplating system 100 can function by reapplying an electrochemical reduction process to the metal-containing waste solution, whereby metal ions in the solution are reduced at the cathode and deposited onto an electrode surface. This step can effectively reduce the concentration of dissolved metal ions in the metal-containing waste solution. In some embodiments, the copper ion concentration ([Cu²⁺]) in the metal-containing waste stream can be lowered from its initial level to approximately 300-500 ppm, and in some cases around 400 ppm. In some embodiments, the metal ions present in the metal-containing waste solution may include not only copper ions (Cu²⁺), but also a broader range of transition metal ions encountered in semiconductor manufacturing processes. These may include nickel (Ni²⁺), cobalt (Co²⁺), zinc (Zn²⁺), iron (Fe²⁺/Fe³⁺), manganese (Mn²⁺), silver (Ag⁺), tin (Sn²⁺/Sn⁴⁺), gold (Au³⁺), palladium (Pd²⁺), and platinum (Pt²⁺/Pt⁴⁺). Such ions may originate from electroplating, etching, or chemical-mechanical polishing (CMP) operations. The FBHC system 110 disclosed herein can be configured to effectively treat waste streams containing any of these metal ions by inducing crystallization under controlled pH and flow conditions, thereby enabling selective recovery or removal of metal-based solids from complex fabrication effluents.

To improve the uniformity and efficiency of metal deposition during this secondary plating process, leveling agents (also referred to as “additives”) may be optionally introduced into the electroplating system 100. In some embodiments, these leveling agents can be organic or inorganic compounds that enhance plating quality by suppressing irregular deposition on microscopic protrusions, improving the smoothness and density of the plated metal layer, and/or promoting more complete and even ion reduction, which in turn enhances the overall metal removal efficiency from the metal-containing waste solution.

However, in embodiments where a downstream FBHC system 110 is employed, the use of leveling agents in electroplating system 100 can be optional. Since a portion of the metal ions can be effectively removed in the FBHC process through controlled crystallization, the dependency on leveling agents can be reduced or eliminated. This not only simplifies chemical management but also contributes to operational cost savings, particularly by reducing additive consumption in the electroplating system 100. In some embodiments, the metal-containing waste solution introduced into the electroplating system 100 can originate directly from the fabrication system 15 (e.g., electroplating apparatus 10) as shown in FIG. 1A, following completion of the initial plating process.

Following the initial treatment in the electroplating system 100, the partially purified metal-containing waste solution, which may include dissolved metal salts such as nickel sulfate, zinc chloride, or iron nitrate, can be directed into a fluidized bed homogeneous crystallization (FBHC) system 110 for advanced metal recovery and further concentration reduction. Within the FBHC system 110, the process conditions can be controlled to induce the nucleation and growth of metal-based crystalline particles from the dissolved metal ions. For example, in the case of copper-containing waste, the crystallized product may form as spherical copper sulfate crystals. These metal-based crystalline particles (also can be referred to as metal salt crystal spheres or metal-containing crystalline granules) can be generated through controlled supersaturation, pH adjustment, and fluidized mixing, enabling efficient solid-phase recovery of target metals. The crystallized particles are then physically separated from the liquid phase by sedimentation, taking advantage of their relatively large particle size and density, which in turn enables the removal of metal ions from the waste solution in a solid, reusable form.

In some embodiments, after treatment in the FBHC system 110, the residual metal ion concentration in the treated metal-containing waste solution can be reduced to as low as about 2-15 ppm, improving compliance with environmental discharge limits. The FBHC system of the present disclosure can operate under low temperature and low pressure conditions, thereby reducing energy consumption. The FBHC system can have a compact footprint, making it suitable for integration into space-limited facilities. The resulting crystalline product can exhibit high purity, low moisture content (less than about 5%), and is in a solid particulate form, making it easy to handle, store, transport, or recycle. The crystallized metal products may be reused in industrial applications, sold as raw materials, or further refined. The FBHC process can serve not only as a high-efficiency metal recovery process, but also as a cost-effective and environmentally sustainable solution for metal-containing wastewater management in semiconductor and electrochemical fabrication environments.

After being treated by the FBHC system 110, the metal-containing waste solution, now reduced in dissolved metal ion concentration, can be directed into a downstream wastewater treatment system 120. This wastewater treatment system 120 can implement a chemical mixing process, wherein a chelating agent such as sodium sulfide (Na₂S) is added to selectively bind with residual metal ions (e.g., Cu²⁺), forming stable, soluble metal-chelate complexes. Once chelation occurs, a coagulant can be introduced to neutralize surface charges and destabilize the metal-chelate complexes, followed by the addition of a flocculant to enhance the aggregation of destabilized particles into larger, visible flocs. These flocs can consist of chelated metal species and other suspended particulates, and can be allowed to settle via gravity to form a solid-phase metal-containing sludge. In some embodiments, the chelating agent, the coagulant, and the flocculant can be supplied from a chemical dosing unit 122 to the wastewater treatment system 120, where the chemical dosing unit 122 may include chemical storage tanks, metering pumps, and automatic controllers. The wastewater treatment system 120 may include a series of chemical reaction tanks for pH adjustment and coagulation, mixers to promote uniform reagent distribution, sedimentation basins or clarifiers for solid-liquid separation, and dewatering equipment such as filter presses or centrifuges for sludge removal.

The sludge then can be separated from the treated liquid phase by sedimentation or filtration. As a result of this multi-step chemical process, the remaining concentration of dissolved metal ions in the effluent can be reduced to less than 1 ppm, meeting strict discharge or reuse standards. In some embodiments, the wastewater treatment system 120 can also accept additional waste streams from other fabrication processes, such as copper chemical mechanical polishing (i.e., Cu CMP), enabling centralized treatment and enhanced resource efficiency. Because the upstream FBHC system already can remove a substantial portion of metal ions through controlled crystallization, the demand for chemical additives, such as Na₂S, coagulants, and flocculants, can be reduced in the wastewater treatment system 120. This not only can lead to material cost savings but also decrease the volume of generated metal-containing sludge, thereby improving sludge dewatering efficiency, reducing transportation and disposal costs, and minimizing environmental impact. Overall, the integration of the FBHC system 110 with the downstream chemical treatment unit can allow for a highly effective, scalable, and economically optimized solution for managing metal-laden industrial wastewater streams.

After undergoing treatment in the wastewater treatment system 120, the metal-containing waste solution can be directed into a discharge pipeline 130. The discharge pipeline 130 can serve as the terminal conduit for transporting the treated effluent out of the facility, either for safe release into an approved wastewater network or for further centralized treatment, depending on regulatory requirements and site-specific configurations. Because the concentration of residual metal ions in the solution has been reduced to below permissible discharge limits (e.g., <1 ppm), the effluent entering the discharge pipeline 130 can be considered environmentally compliant.

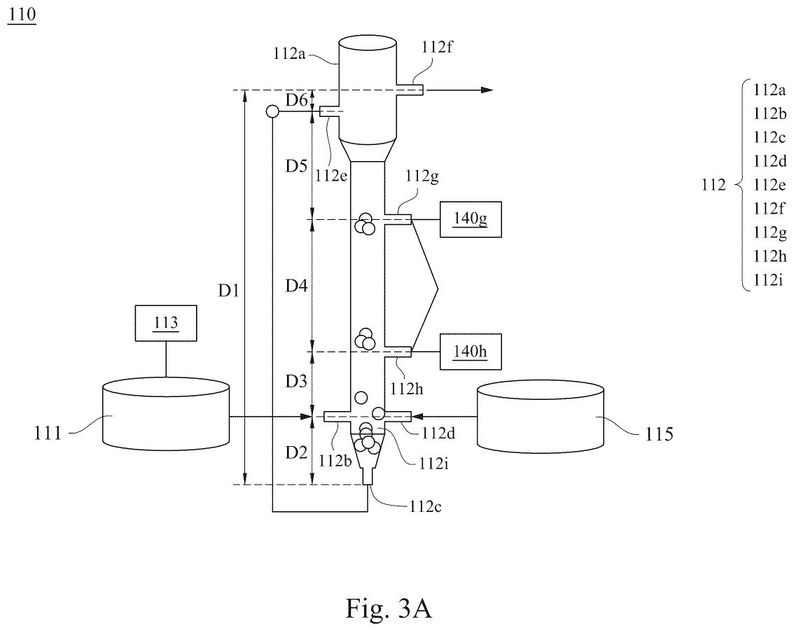

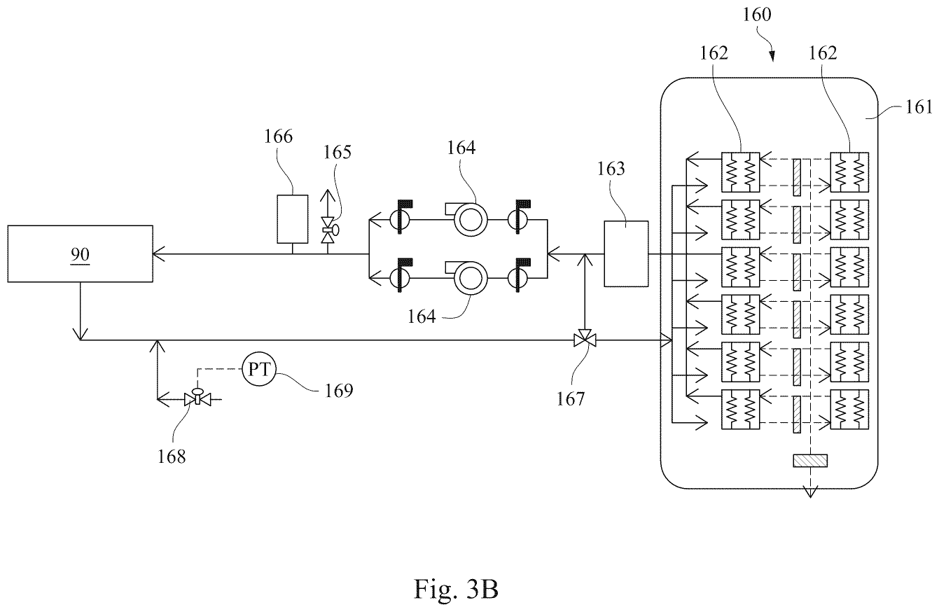

Reference is made to FIG. 3A. FIG. 3A illustrates a reactor used in the fluidized bed homogeneous crystallization technology, in accordance with some embodiments of the present disclosure. In some embodiments, the metal-containing waste solution exiting the electroplating system 100 (see FIG. 2A) may have a strongly acidic pH of approximately 1, due to the presence of acidic electrolyte components such as sulfuric acid. Before the metal-containing waste solution enters the FBHC system 110, it can be first directed into a buffer tank 111. In the buffer tank 111, the acidic metal-containing waste solution can be mixed with a first alkaline agent, which can be supplied from an agent source 113. The first alkaline agent can be a strong base, such as sodium hydroxide (NaOH). The neutralization reaction that occurs between the acidic metal-containing waste solution and the strong alkaline agent can be an acid-base reaction, in which hydroxide ions (OH⁻) from the NaOH react with hydrogen ions (H⁺) present in the acidic waste solution to form water (H₂O). As a result, the pH of the solution can gradually increase. By carefully controlling the amount and rate of NaOH addition, the pH of the metal-containing waste solution can be effectively adjusted from its initial highly acidic state (pH ~1) to a moderately acidic range of pH 3 to 5, such as approximately 3, 4, or 5.

This pH adjustment step can condition the metal-containing waste solution before it enters the subsequent crystallization stage. The neutralized solution can become more chemically stable and suitable for further treatment in the FBHC system 110, where additional pH fine-tuning and crystallization processes can be performed. The FBHC system 110 can comprise three subsystems including a buffer tank 111 for initial pH conditioning, a recirculation device 112 for continuous fluidized crystallization and particle growth, and a buffer tank 113, which provides a second alkaline agent for precise pH control during crystallization, which in turn enables precise stepwise control of pH and crystallization conditions to optimize metal ion removal efficiency and crystal product quality.

In some embodiments, adjusting the pH of the aqueous solution comprises increasing the pH from below about 3.0 to a first target range between about 3.0 and 5.0 by adding a first alkaline agent. This initial pH adjustment can serve to partially neutralize the highly acidic metal-containing solution, improving its chemical stability and reducing corrosiveness before further treatment. Maintaining the pH within this range can help avoid premature precipitation or uncontrolled hydrolysis that may occur above pH 5.0, while also limiting excessive acid content that would require a disproportionate amount of secondary alkaline agent to correct downstream. If the pH remains below 3.0, the solution may remain too aggressive for safe and stable handling and may suppress early-stage complexation reactions necessary for controlled nucleation. Conversely, increasing the pH beyond 5.0 at this stage may induce early precipitation of metal hydroxides or mixed salts, which can reduce process control and impair the efficiency of subsequent crystallization steps.

After the pH of the metal-containing waste solution is adjusted to approximately 3-5 in the buffer tank 111 by mixing with a first alkaline agent (e.g., sodium hydroxide), the metal-containing waste solution can be directed into the recirculation vessel 112a via a metal-containing waste inlet 112b. In some embodiments, the buffer tank 111 can be interchangeable referred to as a pH adjustment module. The recirculation vessel 112a, which forms the core of the recirculation device 112, can be structurally configured as an elongated tubular or cylindrical chamber extending along the vertical axis, and is designed to support continuous fluid flow and particle separation within the FBHC process. In some embodiments, the recirculation vessel 112a can be interchangeable referred to as a recirculation chamber, a reactor, or a vertically oriented fluidized crystallization reactor. In some embodiments, the recirculation device 112 includes a metal-containing waste inlet 112b for introducing pretreated acidic metal-containing waste solution, a recirculation inlet 112c that feeds back part of the treated stream for continuous operation, an alkaline agent inlet 112d for supplying a second, weaker alkaline agent (e.g., sodium carbonate) to finely tune the pH to a range between approximately 6.0 and 7.0 (e.g., 6.5), and a recirculation outlet 112e for removing overflow or recirculated fluid. Additional ports can include a treated metal-containing waste outlet 112f, two vertically spaced sampling ports 112g and 112h for monitoring metal ion concentration at different heights, and a crystal discharge port 112i located near the bottom of the recirculation vessel 112a to remove accumulated crystalline solids.

The second alkaline agent, weaker in basicity than the first alkaline agent, can be introduced in the recirculation vessel 112a to further adjust the solution pH to a second target range between about 6.0 and 7.0. Operating within this range can support a well-regulated crystallization environment in which supersaturation is optimized for uniform nucleation and controlled growth of metal-based solids. This pH window can allow sufficient reduction in solubility to trigger crystallization without pushing the FBHC system 110 into a regime where amorphous precipitates or undesirable by-products form. The pH values below approximately 6.0 may result in insufficient supersaturation and delayed or incomplete crystal formation, while pH above approximately 7.0 may lead to the formation of metal hydroxides with poor structural uniformity and may disrupt fluidized bed stability due to excessive CO₂ degassing or localized alkalinity spikes.

In some embodiments, the vertically oriented design of recirculation vessel 112a can facilitate effective gravitational settling of larger metal-based crystalline particles toward the bottom, while smaller crystals or uncrystallized ions remain in suspension and are subject to further reaction or recirculation. The recirculation vessel 112a can enable precise control of upward fluid velocity for maintaining a fluidized bed regime that supports uniform nucleation, particle growth, and minimization of fouling or channeling. The recirculation vessel 112a can increase the vertical residence time and enhances contact efficiency between reactants, thereby promoting complete pH adjustment and crystallization reactions before discharge. In some embodiments, the recirculation vessel 112a can allows for vertical monitoring of concentration gradients, enabling real-time assessment of crystallization performance and detection of process inefficiencies through the sampling ports. In some embodiments, the recirculation vessel 112a can reduce the equipment's horizontal footprint while maximizing vertical reaction volume. In some embodiments, the recirculation vessel 112a may be constructed from corrosion-resistant materials such as quartz, borosilicate glass, or chemically inert polymers, providing long-term durability and compatibility with both acidic and alkaline process streams used in wastewater metal recovery. In some embodiments, the recirculation vessel 112a may be made of a transparent material.

As the metal-containing waste solution continuously flows into the recirculation vessel 112a through the waste inlet 112b, a second alkaline agent, stored in buffer tank 115 and characterized as a weak base such as sodium carbonate, sodium hydroxide, calcium carbonate, ammonium carbonate, sodium bicarbonate, or magnesium hydroxide, can be simultaneously introduced into the recirculation vessel 112a via an alkaline agent inlet 112d. In some embodiments, this second alkaline agent can function as a pH modifier, alkaline pH adjusting compound, or crystallization-promoting agent, and can be selected to have lower basic strength than the first alkaline agent (e.g., NaOH) used earlier in the buffer tank 111. In some embodiments, the pH difference between the first and second alkaline agents can be at least approximately 2 pH units, with the first alkaline agent being a stronger base (e.g., pH ≥12) and the second alkaline agent being milder (e.g., pH approximately equal to 8-10). In some embodiments, both the metal-containing waste inlet 112b and the alkaline agent inlet 112d can be positioned at the bottom section of the vertically oriented recirculation vessel 112a and, in some embodiments, can be located at the same elevation height. This spatial configuration can allow uniform initial mixing of the metal-containing waste solution and the alkaline agent near the base of the recirculation vessel 112a, promoting consistent local supersaturation and avoiding pH gradients that could otherwise lead to uncontrolled or uneven nucleation. This spatial configuration also can allow the injected flows to naturally co-ascend within the fluidized bed, enhancing vertical mixing efficiency and residence time without disrupting the upward flow pattern that is essential for stable fluidization and crystal growth.

The second alkaline agent can react with dissolved metal ions in the solution, gradually increasing the pH to an optimal range of approximately 6.5, which is for the controlled crystallization of metal-based compounds. At this pH level, many metal salts, such as copper sulfate, can reach or exceed their solubility limits, triggering the precipitation and nucleation of crystalline particles from the aqueous phase. Moreover, this moderate pH can not only support supersaturation-driven nucleation but also provide a balance that minimizes co-precipitation of impurities or amorphous sludge. In some embodiments, the FBHC system 110 can operate without the need for external seed crystals, relying instead on self-nucleation mechanisms wherein initial particles spontaneously form under finely tuned supersaturation conditions, and grow continuously within the fluidized zone. This integration of bottom-entry dual inlets, pH-controlled precipitation, and vertical fluid dynamics enables the FBHC system to efficiently convert dissolved metals into high-purity crystalline solids with consistent morphology and high recovery efficiency.

In some embodiments, the metal-containing waste solution can be continuously fed from buffer tank 111 into the recirculation vessel 112a of the FBHC system 110 at an inlet flow rate ranging from approximately 5-15 mL/min, such as approximately 10 or 15 mL/min, while simultaneously being discharged from the recirculation vessel 112a at a lower flow rate of approximately 10-30 mL/min (e.g., 30 mL/min). In some embodiments, the up-flow rate range of the metal-containing waste solution from the recirculation vessel 112a within the distance D1 is approximately 40-168 mL/min, such as approximately 40, 80, 130 or 168 mL/min. These differential up-flow rates can support the formation of a stable fluidized-bed environment, where the excess liquid volume can recirculate within the system to maintain proper fluid dynamics. The FBHC system 110 can operate as a continuous flow crystallization platform, allowing uninterrupted treatment of the incoming metal-laden solution. By carefully coordinating parameters, including inlet flow rate, solution pH, and up-flow velocity, the FBHC system 110 can achieve controlled supersaturation conditions, which promote rapid and uniform nucleation of metal-based crystalline particles directly within the fluidized zone, which in turn enables consistent particle growth, minimizes fouling or agglomeration, and allows efficient removal of dissolved metal ions from solution while supporting scalable and energy-efficient wastewater treatment performance.

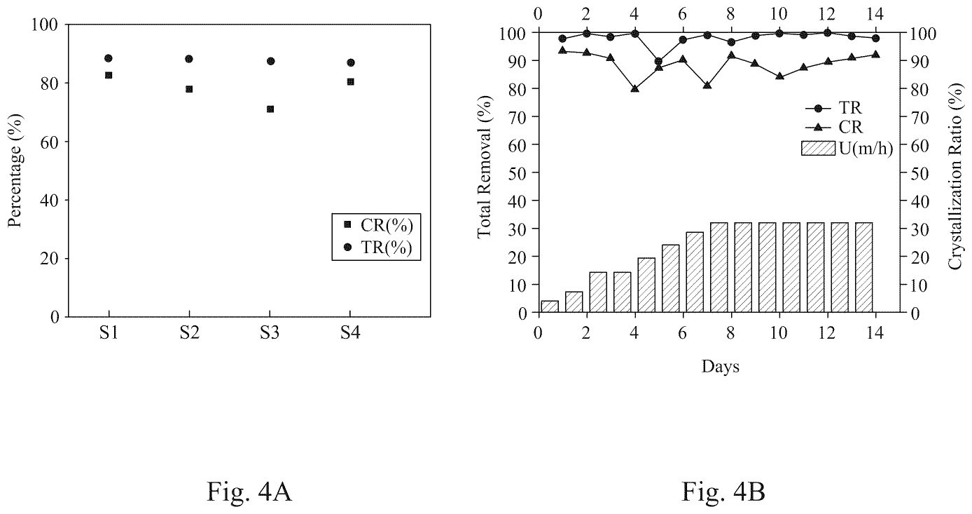

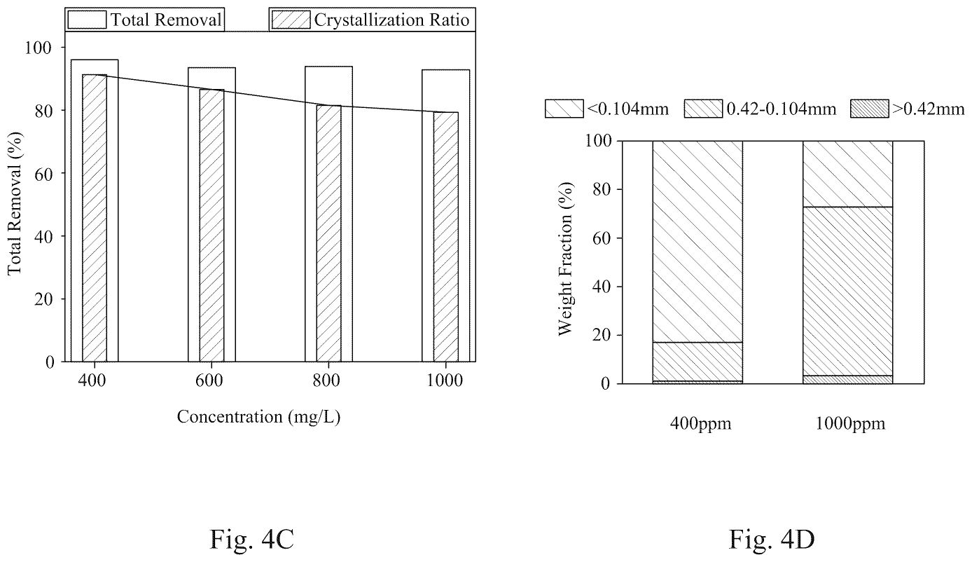

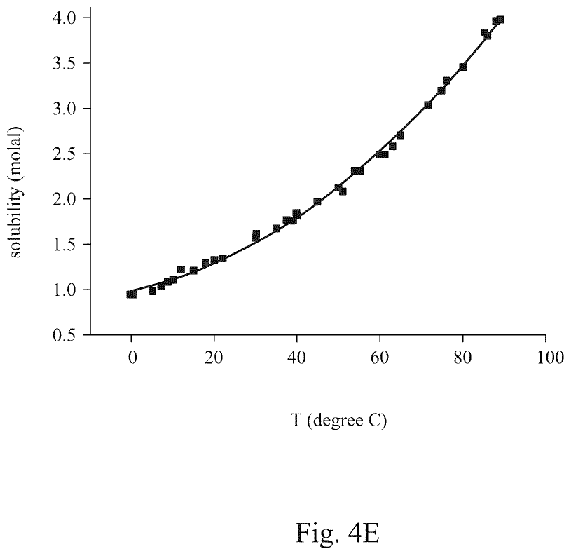

FIG. 4A illustrate the impact of varying inlet flow rates on hydrated copper ion removal efficiency and crystallization performance in the FBHC system 110, under the conditions of [Cu²⁺]=approximately 400 ppm and [CO₃²⁻]/[Cu]=approximately 1.2. Four experimental samples S1-S4 can be compared. In the samples S1, S2, and S3, the inlet flow rates were maintained at constant values of 5, 10, and 15 mL/min, respectively. The sample S4 used a dynamic approach, including starting at approximately 5 mL/min and gradually increasing to approximately 15 mL/min during operation. The removal efficiency (i.e., total metal ion removal, TR) and crystallization ratio (CR) were measured for each condition. TR can refer to the percentage of total copper ions removed from the wastewater, including both crystallized and non-crystallized forms (e.g., those removed via coprecipitation or other pathways). CR can refer to the fraction of copper ions that were successfully converted into solid crystalline form, indicating the effectiveness of the nucleation and crystal growth processes.

Specifically, FIG. 4A can show that lower inlet flow rates (e.g., approximately 5 mL/min in sample S1) result in higher TR and CR values, suggesting more effective nucleation and growth of copper-based crystalline particles. This phenomenon can be attributed to the longer residence time and lower turbulence within the reactor at reduced flow rates, allowing the ions to interact more stably, reach supersaturation locally, and initiate uniform crystal nuclei. Additionally, slower flow may help avoid excessive shear forces that might disrupt early-stage nucleation. However, lower flow rates may inherently limit the throughput of the system. Thus, the sample S4 of beginning with a low flow rate to encourage stable nucleation, then increasing the flow rate to enhance processing capacity, may represent a balanced trade-off between crystallization efficiency and operational productivity. This may illustrate that, in FBHC system 110, while low flow rates enhance crystal formation, they restrict processing capacity, and dynamic flow strategies can help achieve high removal and crystallization performance at scale.

FIG. 4B illustrates a dual-axis chart demonstrating the relationship between up-flow velocity (U, m/h) and both the total metal ion removal rate (TR) and crystallization ratio (CR) over a 14-day continuous operation period within the FBHC system 110, where the test conditions can involve a copper-containing wastewater with an initial concentration of [Cu²⁺]=approximately 400 ppm, a molar ratio of [CO₃²⁻]/[Cu]=approximately 1.2, and a pH maintained at 6.5±0.3. The left y-axis represents the TR and CR percentages, while the right y-axis indicates the corresponding up-flow velocity.

The bars show that up-flow velocity gradually increases from approximately 4.2 m/h to 32.1 m/h during the first 7 days and remains stable at approximately 32.1 m/h from day 8 to day 14. During the initial phase (e.g., days 1-7), while the up-flow velocity is increasing, the TR and CR data points fluctuate without a consistent trend, possibly due to hydrodynamic transitions or process stabilization. After day 7, when the up-flow velocity stabilizes, both the TR and CR can exhibit a steady upward trend, eventually surpassing approximately 90%, indicating that maintaining a stable and sufficiently high up-flow velocity can achieve high removal and crystallization efficiency. The up-flow velocity (U, m/h) can refer to the vertical speed at which the liquid ascends through the reactor's crystallization zone, playing a role in suspending particles, enabling uniform mixing, promoting homogeneous nucleation, and determining the residence time of the reactants. When the up-flow velocity U is too low, crystals may settle and hinder effective reaction, and when the up-flow velocity U is too high, the shear stress may disrupt crystal formation. The experimental results may suggest that the up-flow velocity U in the range of approximately 30-35 m/h may optimize system performance by ensuring proper suspension, reaction uniformity, and stable crystal growth, thus maximizing both TR and CR in the FBHC process.

FIG. 4C present a bar chart that quantifies the effect of varying initial metal ion concentrations on both the total metal ion removal rate (TR) and the crystallization ratio (CR) within the FBHC system 110, in accordance with some embodiments of the present disclosure. The experiment evaluated metal-containing waste solutions with increasing copper ion concentrations of approximately 400, 600, 800, and 1000 ppm, under otherwise identical processing conditions. The results may demonstrate a negative correlation between initial metal ion concentration with the crystallization ratio CR. That is, as the concentration of dissolved metal ions increases, both the fraction of ions removed from the solution and the proportion successfully converted into crystalline solids decrease. This reduction in crystallization efficiency at higher concentrations may be attributed to several interrelated factors. For example, excessive supersaturation at elevated metal ion levels may promote uncontrolled and rapid nucleation, which often leads to the formation of numerous small, poorly structured particles rather than well-formed crystals. Such fine particulates are more likely to remain suspended or redissolve, reducing the overall yield of stable crystalline solids.

Despite these challenges, FIG. 4C also can show that even at a high concentration of approximately 1000 ppm Cu²⁺, the FBHC system 110 may still maintain appreciable levels of TR and CR, underscoring the robustness and scalability of the FBHC system 110. This suggests that, in some applications, the pre-treatment step involving an upstream electroplating system 100, which serves to reduce the metal load, could be partially or entirely bypassed, or operated at reduced power and capacity, thereby lowering operational costs. The FBHC system 110 can directly handle relatively high metal ion loads positions it as a viable standalone or complementary technology for metal recovery and wastewater purification in advanced semiconductor or electroplating facilities.

FIG. 4D illustrates a stacked bar chart comparing the particle size distribution of crystallized solids formed from metal-containing waste solution under two different initial copper ion concentrations, such as approximately 400 ppm and 1000 ppm. The chart can categorize the particle sizes into three classes based on diameter, including particles smaller than approximately 0.104 mm, particles ranging from approximately 0.104 mm to 0.42 mm, and particles larger than approximately 0.42 mm.

At 400 ppm copper concentration, the majority of crystals (approximately 83.02%) fall within the smallest size category (approximately <0.104 mm), with approximately 16.09% in the intermediate range (approximately 0.104-0.42 mm), and only approximately 0.90% in the large particle class (approximately >0.42 mm). Conversely, at 1000 ppm copper concentration, there is a shift in particle size distribution. At 1000 ppm copper concentration, approximately 26.94% of particles are smaller than approximately 0.104 mm, while approximately 69.66% of particles lie in the of particles 0.104-0.42 mm range, and approximately 3.40% of particles are larger than approximately 0.42 mm. This trend may indicate that increasing the initial metal ion concentration promotes the formation of larger crystalline particles.

In some embodiments, higher metal ion concentrations may increase the supersaturation level of the solution, which enhances the growth kinetics of nucleated crystals. In high supersaturation conditions, once nucleation has occurred, the abundance of available metal ions supports sustained crystal growth, leading to larger and more mature crystals in the short term of the reaction. In contrast, at lower metal ion concentrations, while nucleation may still occur, the limited availability of growth rate and the changed growth mechanism of species restricts particle enlargement, resulting in predominantly smaller crystals in this shorter path. In some embodiments, larger crystal particles formed at higher ion concentrations also may tend to have a lower surface area-to-volume ratio, which contributes to improved dewatering characteristics during post-processing. Specifically, larger crystals may exhibit better settling and filtration behavior, reducing the amount of residual bound water within the crystal structure. As a result, the solid product can exhibit a lower moisture content (i.e., better drying efficiency), which in turn minimizes drying energy consumption and decreases transportation costs due to reduced bulk weight and improved handling properties.

Referring back to FIG. 3A, in some embodiments, the recirculation of metal-containing waste solution within the recirculation vessel 112a of the recirculation device 112, achieved via the recirculation inlet 112c and recirculation outlet 112e, can enhance the crystallization efficiency of metal-based particles. In some embodiments, the recirculation inlet 112c can be positioned near the bottom of the recirculation vessel 112a, while the recirculation outlet 112e can be positioned near the top of the recirculation vessel 112a, thereby establishing a vertically oriented flow path that promotes thorough internal mixing and fluid movement. This configuration may facilitate a stable fluidized bed environment, where smaller or uncrystallized metal ions remain suspended and continuously circulated, while larger and denser crystalline particles naturally settle at the bottom due to gravity. The continuous recycling of the upper-layer fluid, enriched with metal ions and small crystallites, may allow these constituents to remain in the supersaturated zone for extended durations, thereby increasing their likelihood of participating in further nucleation or growth onto existing crystal structures. In some embodiments, positioning the recirculation inlet 112c at a lower elevation than the main wastewater inlet 112b and the alkaline agent inlet 112d may allow that incoming fluid enters under minimal disturbance from the vertical recirculation current, minimizing turbulence that could disrupt growing crystals. The upward flow created between the recirculation inlet 112c and recirculation outlet 112e in the vertical configuration may further support stratification within the recirculation vessel 112a, wherein particle size separation occurs naturally, and heavier, well-formed crystals can remain at the bottom while lighter or smaller particles can continue circulating upward, thus promoting selective retention and growth of desired crystalline forms.

Additionally, the recirculation can improve uniformity of pH, temperature, and supersaturation conditions throughout the recirculation vessel 112a. Moreover, recirculating metal ions within a confined, controlled environment allows that metal ions have multiple opportunities to encounter counter-ions (e.g., SO₄²⁻), thereby enhancing the crystallization rate and reducing residual ion concentrations in the treated effluent. In some embodiments, the recirculation flow rate can be maintained in a controlled range of approximately 10-140 mL/min, such as approximately 10, 20, 40, 80 or 140 mL/min, depending on system scale, target throughput, and residence time. Maintaining the internal recirculation flow between approximately 10 and 140 mL/min allows for a balanced operation between fluidization stability and crystallization performance. At flow rates around 10-30 mL/min, the upward velocity can be sufficient to keep smaller particles suspended while limiting excessive agitation. If the flow falls below 10 mL/min, the suspension may become unstable, leading to inconsistent pH distribution, slower ion pairing, and reduced crystallization efficiency. In the range of 30-80 mL/min, the FBHC system 110 can support adequate mixing and residence time, helping to achieve more uniform particle growth and reduce the likelihood of clogging or channeling. At higher rates between 80 and 140 mL/min, increased flow can promote improved mixing and temperature uniformity, which may be beneficial when handling more concentrated or preheated streams. Flow rates above 140 mL/min, however, may generate excessive turbulence that can disrupt crystal formation, lead to premature particle discharge, or increase energy consumption. Keeping the recirculation within this range can help the FBHC system 110 maintain stable and effective operating conditions for removing metal ions from solution. Continuous operation during the inflow and outflow of metal-containing waste solution from the buffer tank 111 can allow the crystallization to occur dynamically within the circulating flow, enabling scalable and energy-efficient metal ion removal. The recirculation mechanism itself can serve not only to improve crystal uniformity and size distribution but also to stabilize the FBHC system 110, allowing the FBHC system 110 to operate efficiently at a steady state.

In some embodiments, analytical techniques such as scanning electron microscopy (SEM), energy-dispersive X-ray spectroscopy (EDS), and X-ray diffraction (XRD) can confirm the composition and morphology of the precipitated solids. These analyses may reveal that the resulting crystals include hydrated copper sulfates such as (Cu₄(SO₄)(OH)₆·H₂O), verifying the effectiveness of the crystallization process.

As crystallization progresses within the recirculation vessel 112a of the FBHC system 110, the metal-based crystalline particles may gradually accumulate near the bottom of the recirculation vessel 112a due to gravity. These particles, such as hydrated copper sulfate crystals, can be denser and larger than the surrounding solution, and thus naturally settle as they reach a critical mass and size. During continuous operation, the recirculation of the metal-containing waste solution can promote the ongoing supersaturation and growth of the crystals, while also allowing smaller or immature particles to remain in suspension and continue circulating. This fluid dynamic can allow that only fully formed or larger particles can be retained at the bottom, while lighter species are given more time to crystallize. Over time, as the volume of settled crystalline material increases and reaches a predefined threshold, for example, over half the height of the recirculation chamber, the FBHC system 110 may pause or adjust the recirculation process to facilitate product recovery. At this stage, the accumulated crystalline solids can be removed through a designated crystal discharge port 112i, which is positioned near the base of the recirculation vessel 112a. This process can enables periodic batch-off or continuous discharge of high-purity, low-moisture crystalline products with minimal interruption to the upstream feed or downstream processing.

In the FBHC system 110, the efficiency of metal ion removal and crystal formation can be evaluated in real time by monitoring metal ion concentration gradients at different vertical positions within the recirculation vessel 112a. To enable this, the FBHC system 110 can be equipped with two sampling ports located at different heights, a higher-positioned sampling port 112g and a lower-positioned sampling port 112h. These sampling ports 112g and 112h can allow collection and measurement of the metal ion concentrations in the metal-containing waste solution at those respective vertical levels.

By comparing the concentration values obtained from the sampling ports 112g and 112h, the FBHC system 110 can assess the crystallization progress along the vertical flow path. A concentration drop from the upper to the lower region can indicate that metal ions are being effectively consumed through crystal formation as the solution moves downward, thus reflecting efficient system operation. Conversely, a small or negligible concentration difference between the upper and lower sampling points may imply insufficient crystallization or poor metal removal performance, potentially due to suboptimal conditions within the recirculation device 112.

For instance, if the influent metal ion concentration is approximately 400 ppm, and the metal ion concentration detected at the upper sampling port 112g may range between approximately 100-200 ppm, while the lower sampling port 112h may measure approximately 35-50 ppm, the FBHC system 110 would be considered efficient. Specifically, if the lower concentration is less than half the upper concentration (i.e., the concentration at the upper sampling port 112g is <50% of that at the lower sampling port 112h), the crystallization efficiency may be deemed acceptable. On the other hand, if the concentration at the upper sampling port 112g is greater than half of that at the lower sampling port 112h, this would suggest incomplete metal removal and insufficient crystallization, thus prompting corrective actions. These actions could involve adjusting operational parameters, such as the inlet flow rate to control residence time, the amount of first and second alkaline agents to fine-tune the pH and supersaturation levels, or the recirculation flow rate to optimize contact time and mixing. This inline concentration-based monitoring strategy can offer a quantitative and dynamic performance metric, enabling real-time process control, fault detection, and system optimization, thereby ensuring consistently high yields of metal-based crystalline solids with reduced downstream treatment burdens.

In some embodiments of the FBHC system 110, real-time monitoring of metal ion concentration at different vertical levels within the recirculation vessel 112a can be achieved through integrated concentration detection devices, specifically, sensors 140g and 140h installed at sampling ports 112g and 112h, respectively. These sensors 140g and 140h can continuously measure the concentration of metal ions in the metal-containing waste solution at their respective elevations, thereby enabling precise tracking of crystallization performance across the vertical flow path.

In some embodiments, the acquired concentration data from the sensors 140g and 140h can be transmitted to the archive database 75 (see FIG. 1A), which logs and stores the values for historical analysis and traceability. Simultaneously, this data can be processed by the fault detection and classification system 55 (see FIG. 1A), which calculates the concentration differential between the two vertical points. If the concentration difference falls below a predefined acceptable threshold, suggesting poor crystallization efficiency or insufficient metal ion removal, the FDC system can trigger a signal to the control system 60 (see FIG. 1A). The control system 60 can respond in one of two ways. First, it can alert operational personnel to perform diagnostics, inspections, or manual interventions. Alternatively, for enhanced process automation, the control system 60 may be configured to autonomously shut down the FBHC system 110 to prevent further inefficiencies or process deviations. More advanced embodiments enable automatic process correction, wherein the control system dynamically adjusts operational parameters, such as inlet flow rate, dosage of the first and second alkaline agents, and recirculation rate, based on real-time feedback from the concentration data.

In some embodiments, the defined spatial configuration of the flow paths and ports within the recirculation vessel 112a, characterized by distances D1 through D6, can optimize the performance, efficiency, and controllability of the FBHC system 110. The distance D1, defined as the vertical distance between the recirculation inlet 112c and the recirculation outlet 112e, can be designed to be sufficiently long (e.g., approximately 60-100 cm) to allow for extended vertical residence time. This promotes effective stratification of the crystallization environment, enabling heavier and more mature metal-based crystalline particles to settle near the bottom, while lighter or still-nucleating species continue circulating for further growth, thereby enhancing crystallization yield and particle size uniformity.

The distance D2, defined as the vertical distance between the metal-containing solution/alkaline agent inlets 112b/112d and the recirculation inlet 112c, is kept relatively short (e.g., approximately 10-20 cm), which can minimize stagnation zones and allow immediate mixing of incoming solutions with the bulk flow. This encourages prompt chemical interaction and pH adjustment required for nucleation. When the distance D2 is substantially equal to the distance D3 and/or the distance D4, this symmetrical positioning of the sampling ports 112g and 112h relative to the inlet region enables accurate gradient-based concentration profiling across different vertical zones for real-time monitoring of crystallization progression and system efficiency. The distances D3 and D4, each in the range of 10-20 cm, can be configured to provide optimal sampling resolution for detecting metal ion concentration differentials. The upper sampling port 112g and lower sampling port 112h can be placed to capture vertical chemical stratification, offering reliable input to the control system 60 for feedback regulation.

The distance D5, which spans from the recirculation outlet 112e to the metal-containing waste outlet 112f, can be comparatively larger (e.g., approximately 20-30 cm), allowing for accumulation and buffering of fully treated liquid before discharge. This extra vertical headspace can reduce turbulence near the metal-containing waste outlet 112f, preventing re-suspension of settled crystalline particles. The distance D6, between the recirculation outlet 112e and the treated liquid outlet 112f, can be the shortest (e.g., approximately 5-10 cm), ensuring that fluid designated for recirculation exits efficiently without prematurely mixing with the final effluent stream.

In some embodiments, the configuration can allow laminar vertical flow, effective sedimentation dynamics, precise monitoring of vertical concentration gradients, and controlled discharge of treated effluent. In some embodiments, the diameter of the recirculation vessel 112a, ranging from 2 to 100 cm², such as approximately 2, 10, 50 or 100 cm², may provide a narrow vertical channel that enhances fluid velocity for fluidization while maintaining manageable residence time for crystallization kinetics.

Reference is made to FIG. 3B. FIG. 3B illustrates a volatile organic compound (VOC) exhaust system 160 with a heat exchanger 161, configured to heat the metal-containing waste solution and to dry the sludge formed from the metal-containing waste solution, in accordance with some embodiments of the present disclosure. In some embodiments of the present disclosure, the metal-containing waste solution may be preheated to a temperature range of approximately 30° C. to 100° C. (e.g., 30, 40, 50, 60, 70, 75, 80, 90, or 100° C.) before being introduced into the electroplating system 100 and/or the FBHC system 110 (see FIG. 2A) or the waste treatment system 90. The crystallization process is primarily driven by supersaturation in the solution, with temperature being a crucial factor affecting both supersaturation and the driving force for crystallization. Preheating the metal-containing waste solution can enhance the solubility of metal ions and other dissolved constituents, which in turn influences supersaturation and the change in free energy (AG), thus promoting crystallization improves both the metal removal rate and the crystallization ratio in the downstream FBHC system 110. In some embodiments, higher temperatures generally can increase the kinetic energy of the molecules in the solution, which facilitates more efficient ion dissociation and improves the mass transfer rates. For example, this enhanced solubility and mobility can allow for more uniform metal deposition on the cathode and a higher fraction of metal ions to be removed during electrochemical reduction. As a result, the electroplating system 100 and/or the FBHC system 110 can become more effective in reducing the bulk metal ion concentration in the wastewater before it is transferred downstream. FIG. 4E shows a line chart illustrating the solubility behavior of metal salts (e.g., copper sulfate) as a function of temperature. Crystallization occurs more rapidly, possibly due to faster surface integration or quicker equilibrium between molecular conformers at elevated temperatures. Thermodynamically, supersaturation (Sa) can be represented by the ratio of solute concentration in the solution to its saturation concentration. When temperature increases, the system can achieve a greater free energy difference, enhancing the driving force for crystallization. In specific reactions (such as copper adsorption and crystallization), operating at 30-40° C. can enhance adsorption and crystallization efficiency, improving crystal habit and quality. This counterintuitive behavior, observed with salts that form hydrate complexes (e.g., Cu₄(SO₄)(OH)₆·H₂O), becomes advantageous during the FBHC process. After electroplating at higher temperatures, as the heated waste solution flows into the FBHC system 110 and can be allowed to cool or is brought to a controlled pH (e.g., around 6.5), the reduced solubility at this point can facilitate spontaneous crystallization of the metal salts.

As shown in FIG. 3B, the VOC exhaust system 160 with the heat exchanger 161 can heat the metal-containing waste solution and drying the sludge produced from the wastewater treatment system 120 (see FIG. 2A). This configuration can offer an energy-efficient and sustainable approach to thermal management within a fabrication facility 1 by utilizing waste heat. The VOC system 160 can incinerate volatile organic compounds present in factory exhaust gases, thereby generating a amount of thermal energy as a byproduct. Instead of releasing this heat into the environment, the VOC system 160 can direct it into the heat exchanger 161, which is composed of multiple heat exchange elements 162. These heat exchange elements 162 can transfer thermal energy to a working fluid, water or another heat-transfer medium, that flows through them. The heated fluid exiting the heat exchanger 161 is then directed to a buffer tank 163, which helps regulate the temperature and flow stability before being circulated through the system using a circulation pump 164. A pressure release valve 165 can be installed downstream to allow safe operation under varying thermal conditions and system pressures.

This heated fluid can be then used to warm the metal-containing waste solution, such as electroplating wastewater, either directly via heat exchange. As the heated fluid transfers its thermal energy to the metal-containing solution, its temperature decreases. The cooled fluid is either recirculated back into the heat exchanger 161 for reheating or returned to the circulation loop via the pump 164 to repeat the thermal exchange cycle. Additionally, the system can be extended to dry the sludge produced from the chemical treatment process of the wastewater. By exposing the sludge to the heat recovered from VOC combustion, its moisture content is reduced, which significantly decreases sludge volume and weight, improving handling efficiency and reducing disposal costs. This closed-loop thermal system not only improves the energy efficiency of wastewater and sludge treatment but also repurposes industrial waste heat for process enhancement, thereby reducing the overall environmental footprint of the semiconductor manufacturing facility.

In some embodiments, the VOC exhaust system 160 may further include an expansion tank (ET) 166, a decoupling valve 167, a make-up water supply line 168, and a pressure transmitter (PT) 169. The expansion tank 166 may serve as an expansion reservoir for the heated fluid circulating through the system. In some embodiments, the expansion tank 166 can accommodate thermal expansion of the fluid as it is heated in the VOC exhaust heat recovery loop, thereby maintaining stable system pressure and preventing overpressurization due to thermal volume increase. The decoupling valve 167 may be a thermal decoupling valve, which may isolate the upstream VOC exhaust heating loop from the downstream fluid delivery system. In some embodiments, the decoupling valve 167 can allow hydraulic separation and flow control between the recirculating heating loop and the target heating application (e.g., the FBHC or electroplating system), allowing for flow balancing or emergency bypass as needed. The make-up water supply line 168 can be the make-up water feed, supplying softened water (e.g., free from calcium and magnesium) to replenish losses in the heating loop. In some embodiments, the make-up water supply line 168 can allow consistent system fluid volume, compensating for evaporation or minor leakage, and the soft water specification prevents scale formation that would impair heat exchange efficiency. The pressure transmitter 169 can be a pressure monitoring unit that continuously measures system pressure to allow safe and optimal operation of the fluid circulation loop. It can trigger alerts or control logic if pressure deviates from the desired range, protecting system components and maintaining operational integrity.

Reference is made to FIGS. 2B-2D. FIGS. 2B-2D are block diagrams of a fabrication facility 1 for processing metal-containing waste solutions, respectively, corresponding to the system as shown in FIG. 2A, in accordance with some embodiments of the present disclosure. While FIGS. 2B-2D illustrate embodiments of the block diagrams for processing the metal-containing waste solutions with different configurations than that shown in FIG. 2A, the present disclosure may repeat reference numerals and/or letters in the various examples. This repetition is for simplicity and clarity and does not dictate a relationship between the various embodiments and/or configurations discussed.

As shown in FIG. 2B, a distinction between the embodiment illustrated in FIG. 2B and the embodiment in FIG. 2A may lie in the absence of the wastewater treatment system 120. In some embodiments, as illustrated in FIG. 2B, the wastewater treatment system 120 can be omitted from the fabrication facility 1 due to the incorporation of the FBHC system 110. The FBHC system 110 can enable highly efficient removal of metal ions directly from the metal-containing waste solution through a controlled crystallization process, which reduces the residual metal ion concentration to levels that would require additional treatment via chemical precipitation methods involving chelating agents, coagulants, and flocculants. This direct and efficient removal of metal ions, such as copper, zinc, or nickel, through the FBHC system 110 can lower the post-treatment concentration of metal ions to less than 1-2 ppm, which is within or close to regulatory discharge limits, thereby rendering the subsequent chemical wastewater treatment unnecessary under certain operating conditions.

The ability to omit the wastewater treatment system 120 can be attributed to the high crystallization efficiency of the FBHC system 110, which forms well-defined metal-based crystalline particles (e.g., copper sulfate granules) by adjusting solution pH and flow dynamics within a fluidized reactor (e.g., recirculation device 112 shown in FIG. 3A). These crystalline particles can be physically separated via sedimentation or filtration without generating large volumes of sludge, as would be the case with traditional chemical precipitation. By eliminating the use of wastewater treatment system 120, the facility can reduce its chemical consumption (e.g., Na₂S, polymeric flocculants), sludge generation and associated disposal costs, and operational complexity. Additionally, it improves process sustainability and reduces equipment footprint, making the overall system more compact, energy-efficient, and environmentally friendly. Despite omitting the wastewater treatment system 120, the final effluent quality can remain acceptable because the FBHC system 110 alone may be capable of achieving total metal removal efficiency and crystallization ratio above 90%, as demonstrated in experimental results. This proves that the system configuration shown in FIG. 2B maintains both environmental compliance and operational performance, while offering simplification and cost savings.

As shown in FIG. 2C, a distinction between the embodiment illustrated in FIG. 2C and the embodiment in FIG. 2A may lie in the absence of the electroplating system 100. In some embodiments, as illustrated in FIG. 2C, the electroplating system 100 can be omitted from the fabrication facility 1 due to the integration of the FBHC system 110, which provides a direct and effective method for removing metal ions from metal-containing waste solutions. In some embodiments, the electroplating system 100 can be used to remove a portion of metal ions, such as copper, from spent process solutions by electrodeposition, reducing the concentration from several hundred ppm to below 500 ppm. However, this approach may involve electrical energy consumption, electrode maintenance, and sometimes the addition of leveling agents or additives, which increase operational complexity and cost.

With the implementation of the FBHC system 110, the FBHC system 110 may be capable of reducing metal ion concentrations from high levels (e.g., approximately 400-1000 ppm) to low levels (e.g., approximately <15 ppm) through controlled crystallization. The FBHC system 110 can achieve this by optimizing pH adjustment, reagent dosing (e.g., carbonate), and fluid dynamics to promote in-situ nucleation and growth of highly pure, filterable metal salt crystals such as hydrated copper sulfate. These crystalline particles are easily separated from the solution without producing significant sludge, thereby achieving high total removal and crystallization ratios exceeding 90%, even without upstream electroplating. By omitting the electroplating system 100, the overall system architecture can become more streamlined, with reduced energy demands, fewer consumables (e.g., leveling agents), and less equipment to maintain. Additionally, it can reduce space requirements and simplifies process control, leading to lower capital and operational expenditures.

As shown in FIG. 2D, a distinction between the embodiment illustrated in FIG. 2D and the embodiment in FIG. 2A may lie in the absence of the electroplating system 100 and wastewater treatment system 120. In some embodiments, as illustrated in FIG. 2D, the system configuration can omit both the electroplating system 100 and the wastewater treatment system 120, made possible by the integration of the FBHC system 110. This is because the FBHC system 100 alone may be capable of effectively reducing metal ion concentrations in metal-containing waste solutions through controlled crystallization, without preliminary electroplating removal or secondary chemical treatments. The FBHC system 110 can promote the nucleation and growth of crystalline metal salts (e.g., hydrated copper sulfate) by managing pH, reagent dosing (e.g., carbonate addition), flow rate, and temperature. These crystalline particles can be highly pure, easily separable, and significantly reduce the residual metal ion concentration to levels acceptable for discharge or further processing (e.g., approximately <15 ppm or even approximately <1 ppm). As a result, the final treatment performance may remain effective and compliant with environmental standards, even without the additional systems.

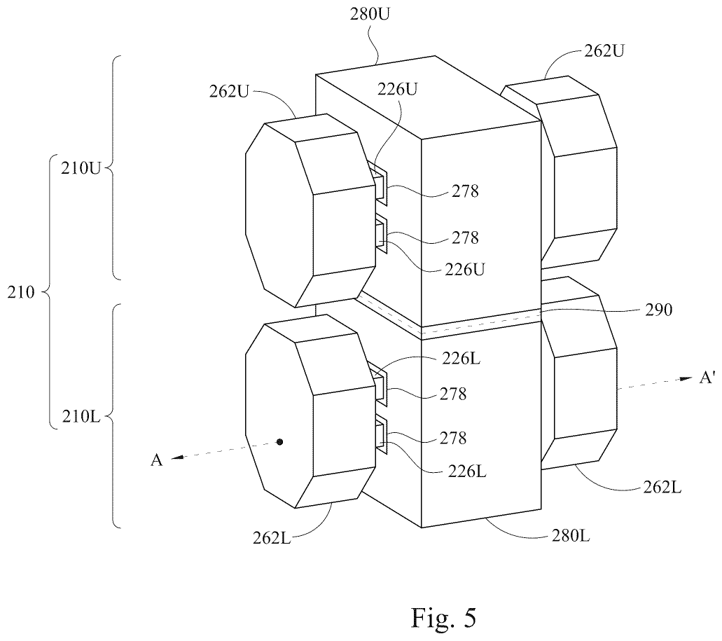

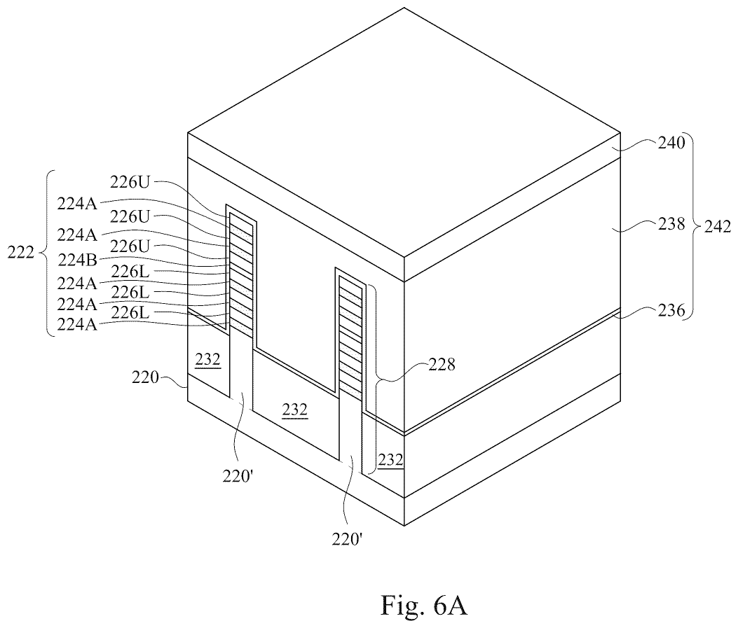

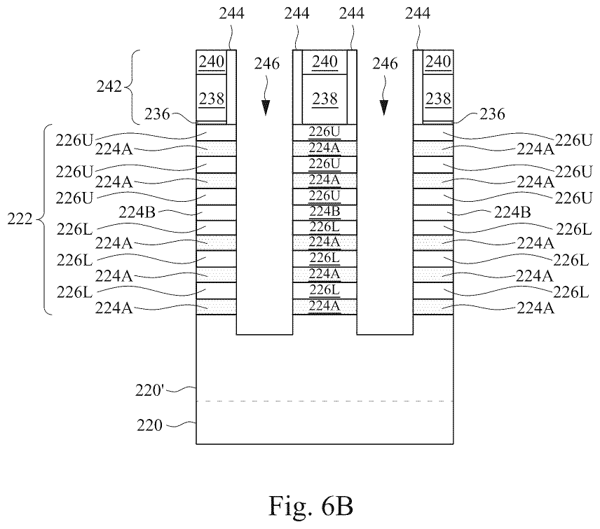

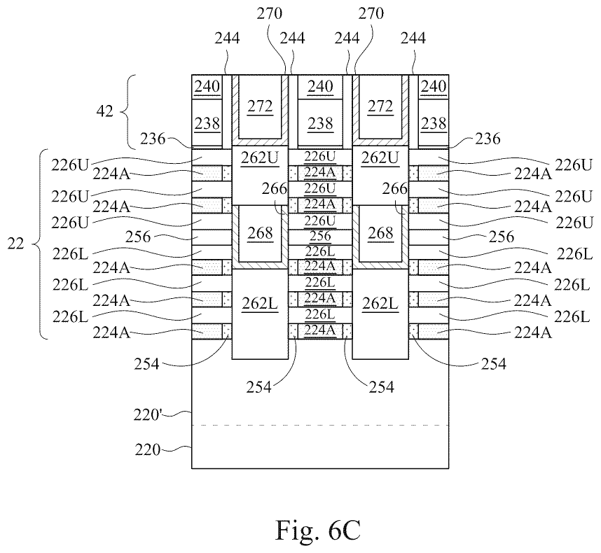

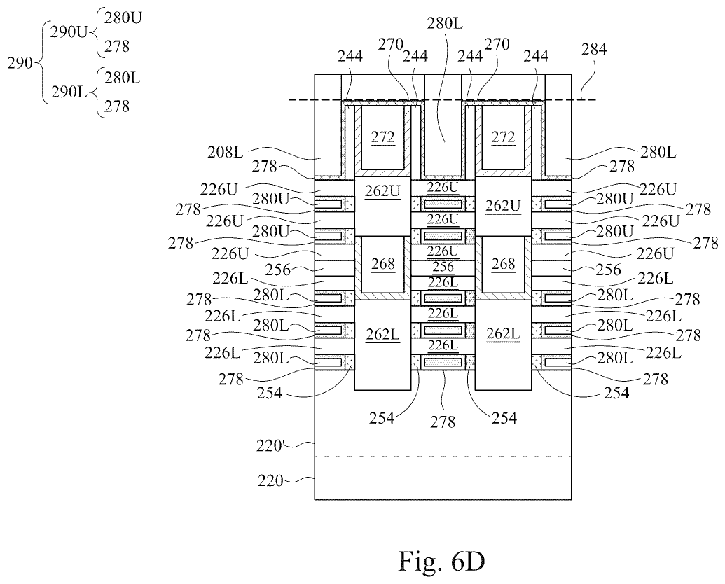

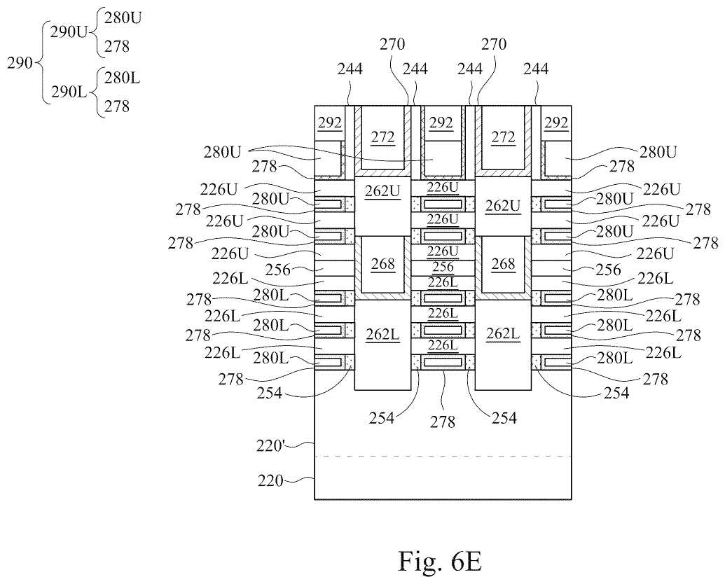

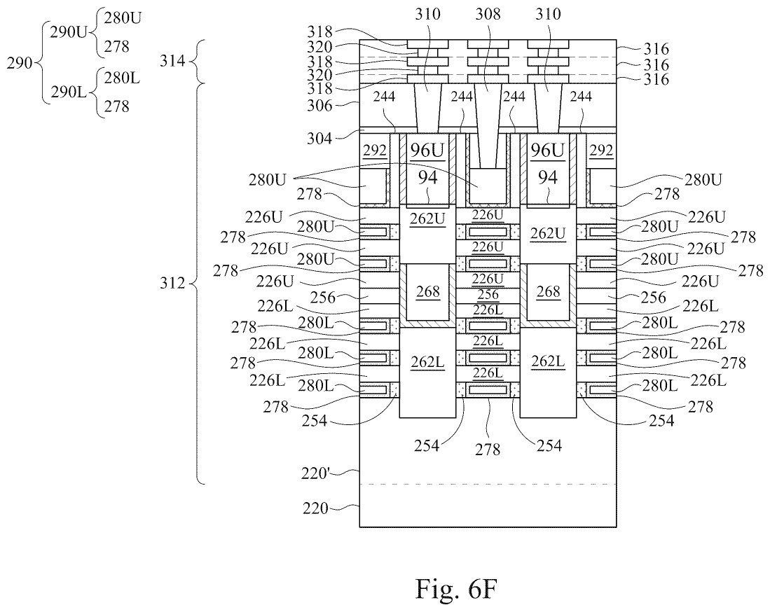

The techniques disclosed in FIGS. 2A-3B, specifically the FBHC system 110 used for metal ion removal from waste solutions, can be applied to semiconductor manufacturing processes like those shown in FIGS. 5-6F. In semiconductor fabrication, high-purity process conditions and precise removal of metal residues from plating, etching, or cleaning steps can improve device yield and reliability. The FBHC system 110, with its ability to efficiently and continuously remove metal ions through controlled crystallization under tailored pH, flow, and temperature conditions, can offer a scalable solution for reclaiming or purifying process chemicals and wastewater streams in front-end or back-end semiconductor fabs. For instance, during the formation of stacked nanosheet CFETs, various wet processes involve exposure to metal ions (e.g., copper, cobalt, nickel) from electroplating baths, etchants, or precursors. If left untreated, such contaminants can cause device degradation or leakage. By integrating an FBHC module into the fab's utility or reclaim system, one can efficiently crystallize and remove residual metal ions with minimal sludge generation, enabling reuse of ultrapure water or chemicals and enhancing fab sustainability. Furthermore, the system's compatibility with continuous operation can align well with high-throughput semiconductor production lines. This connection can establish a relevant foundation to introduce the embodiments in FIGS. 5-6F, illustrating how the waste remediation or chemical conditioning strategy shown in earlier figures translates to process control in transistor architectures like CFETs.

Reference is made to FIG. 5. FIG. 5 illustrates an example of CFETs 210 (including FETs (transistors) 210U and 210L) in accordance with some embodiments. FIG. 5 is a three-dimensional view, wherein some features of the CFETs are omitted for illustration clarity.

The CFETs include multiple vertically stacked FETs. For example, a CFET may include a lower nanostructure-FET 210L of a first device type (e.g., n-type/p-type) and an upper nanostructure-FET 210U of a second device type (e.g., p-type/n-type) that is opposite the first device type. The nanostructure-FETs 210U and 210L include semiconductor nanostructures 226 (including lower semiconductor nanostructures 226L and upper semiconductor nanostructures 226U), where the semiconductor nanostructures 226 act as the channel regions for the nanostructure-FETs. The lower semiconductor nanostructures 226L are for the lower nanostructure-FET 210L, and the upper semiconductor nanostructures 226U are for the upper nanostructure-FET 210U. In other embodiments, the CFETs may be applied to other types of transistors (e.g., FinFETs, or the like) as well.

Gate dielectrics 278 encircle the respective semiconductor nanostructures 226. Gate electrodes 280 (including a lower gate electrode 280L and an upper gate electrode 280U) are over the gate dielectrics 278. Source/drain regions 262 (including lower source/drain regions 262L and upper source/drain regions 262U) are disposed on opposing sides of the gate dielectrics 278 and the respective gate electrodes 280. The source/drain region may refer to a source or a drain, individually or collectively dependent upon the context. Isolation features (not shown) may be formed to separate desired ones of the source/drain regions 262 and/or desired ones of the gate electrodes 280.

FIG. 5 further illustrates a reference cross-section that is used in later figures. Cross-section A-A′ is a vertical cross-section that is parallel to a longitudinal axis of the semiconductor nanostructures 226 of a CFET and in a direction of, for example, a current flow between the source/drain regions 262 of the CFET. Subsequent figures may refer to this reference cross-section for clarity.

Reference is made to FIGS. 6A-6F. FIGS. 6A through 6F illustrate the cross-sectional views of intermediate stages in the formation of CFETs (as schematically represented in FIG. 5) in accordance with some embodiments.

In FIG. 6A, a wafer, which includes substrate 220, is provided. Substrate 220 may be a semiconductor substrate, such as a bulk semiconductor, a semiconductor-on-insulator (SOI) substrate, or the like, which may be doped (e.g., with a p-type or an n-type dopant) or undoped. The SOI substrate may include a layer of a semiconductor material formed on an insulator layer. The insulator layer may be, for example, a buried oxide (BOX) layer, a silicon oxide layer, or the like. The insulator layer is provided on a substrate, such as a silicon or glass substrate. Other substrates, such as a multi-layered or gradient substrate may also be used. In some embodiments, the semiconductor material of the substrate 220 may include silicon, germanium, carbon-doped silicon, a III-V compound semiconductor; or the like, or combinations thereof.

Semiconductor strips 228 are formed extending upwards from the semiconductor substrate 220. Each of semiconductor strips 228 includes semiconductor strip 220′ (patterned portions of the semiconductor substrate 220) and multi-layer stack 22. The stacked component of the multi-layers stack 22 is referred to as nanostructures hereinafter. Specifically, the multi-layer stack 22 includes dummy nanostructures 224A, dummy nanostructures 224B, lower semiconductor nanostructures 226L, and upper semiconductor nanostructures 226U. Dummy nanostructures 224A and dummy nanostructures 224B may further be collectively referred to as dummy nanostructures 224 and the lower semiconductor nanostructures 226L and the upper semiconductor nanostructures 226U may further be collectively referred to as semiconductor nanostructures 226.

The dummy nanostructures 224A are formed of a first semiconductor material, and the dummy nanostructures 224B is formed of a second semiconductor material different from the first semiconductor material. The first and second semiconductor materials may be selected from the candidate semiconductor materials of the substrate 220. The first and second semiconductor materials have a high etching selectivity to one another. As such, the dummy semiconductor layer 224B may be removed at a faster rate than the dummy semiconductor layers 224A in subsequent processes.

The semiconductor nanostructures 226 (including the lower semiconductor nanostructures 226L and upper semiconductor nanostructures 226U) are formed of one or more third semiconductor material(s). The third semiconductor material(s) may be selected from the candidate semiconductor materials of the substrate 220. The lower semiconductor nanostructures 226L and the upper semiconductor nanostructures 226U may be formed of the same semiconductor material, or may be formed of different semiconductor materials. Further, the first and second semiconductor materials of the dummy nanostructure 224 have a high etching selectivity to the third semiconductor material(s) of the semiconductor nanostructures 226. As such, the dummy nanostructure 224 may be selectively removed in subsequent process steps without significantly removing the semiconductor nanostructures 226. In some embodiments, dummy semiconductor nanostructures 224A are formed of or comprise silicon germanium, semiconductor layers 226 are formed of silicon, and dummy semiconductor nanostructures 224B may be formed of germanium or silicon germanium with a higher germanium atomic percentage than the semiconductor nanostructures 224A.

The lower semiconductor nanostructures 226L will provide channel regions for lower nanostructure-FETs of the CFETs. The upper semiconductor nanostructures 226U will provide channel regions for upper nanostructure-FETs of the CFETs. The semiconductor nanostructures 226 that are immediately above/below (e.g., in contact with) the dummy nanostructures 224B may be used for isolation and may or may not act as channel regions for the CFETs. The dummy nanostructures 224B will be subsequently replaced with isolation structures. The isolation structures and the middle semiconductor nanostructures 226M may define boundaries of the lower nanostructure-FETs and the upper nanostructure-FETs.

To form the semiconductor strips 228, layers of the first, second, and third semiconductor materials (arranged as illustrated and described above) may be deposited over the semiconductor substrate 220. The layers of the first, second, and third semiconductor materials may be grown by a process such as Vapor Phase Epitaxy (VPE) or Molecular Beam Epitaxy (MBE), deposited by a process such as Chemical Vapor Deposition (CVD) process or an Atomic Layer deposition (ALD) process, or the like. Then, a patterning process may be applied to the layers of the first, second, and third semiconductor materials as well as the semiconductor substrate 220 to define the semiconductor strips 228, which includes the semiconductor fins 220′, the dummy nanostructure 224, and the semiconductor nanostructures 226. The semiconductor fins and the nanostructures may be patterned by any suitable method. For example, the patterning process may include one or more photolithography processes, including double-patterning or multi-patterning processes. Generally, double-patterning or multi-patterning processes combine photolithography and self-aligned processes, allowing patterns to be created that have, for example, pitches smaller than what is otherwise obtainable using a single, direct photolithography process. For example, in one embodiment, a sacrificial layer is formed over a substrate and patterned using a photolithography process. Spacers are formed alongside the patterned sacrificial layer using a self-aligned process. The sacrificial layer is then removed, and the remaining spacers may then be used as an etching mask for the patterning process to etch the layers of the first, second, and third semiconductor materials and the semiconductor substrate 220. The etching may be performed by any acceptable etch process, such as a Reactive Ion Etch (RIE), Neutral Beam Etch (NBE), the like, or a combination thereof. The etching may be anisotropic.

As also illustrated by FIG. 6A, STI regions 232 are formed over the substrate 220 and between adjacent semiconductor strips 228. STI regions 232 may include a dielectric liner and a dielectric material over the dielectric liner. Each of the dielectric liner and the dielectric material may include an oxide such as silicon oxide, a nitride, such as silicon nitride, the like, or a combination thereof. The formation of the STI regions 232 may include depositing the dielectric layer(s), and performing a planarization process such as a CMP process, a mechanical polishing process, or the like to remove excess portions of the dielectric materials. The deposition processes may include ALD, High-Density Plasma CVD (HDP-CVD), Flowable CVD (FCVD), the like, or a combination thereof. In some embodiments, the STI regions 232 include silicon oxide formed by an FCVD process, followed by an anneal process. Then, the dielectric layers(s) are recessed to define the STI regions 232. The dielectric layer(s) may be recessed such that upper portions of semiconductor strips 228 (including multi-layer stacks 22) protrude higher than the remaining STI regions 232.

After the STI regions 232 are formed, dummy gate stacks 242 may be formed over and along sidewalls of the upper portions of the semiconductor strips 228 (the portions that protrude higher than the STI regions 232). Forming the dummy gate stacks 242 may include forming dummy dielectric layer 236 is formed on the semiconductor strips 228. Dummy dielectric layer 236 may be formed of or comprise, for example, silicon oxide, silicon nitride, a combination thereof, or the like, and may be deposited or thermally grown according to acceptable techniques. A dummy gate layer 238 is formed over the dummy dielectric layer 236. The dummy gate layer 238 may be deposited, for example, through Physical Vapor Deposition (PVD), CVD, or other techniques, and then planarized, such as by a CMP process. The material of dummy gate layer 238 be conductive or non-conductive, and may be selected from a group including amorphous silicon, polycrystalline-silicon (polysilicon), poly-crystalline silicon-germanium (poly-SiGe), or the like. A mask layer 240 is formed over the planarized dummy gate layer 238, and may include, for example, silicon nitride, silicon oxynitride, or the like. Next, the mask layer 240 may be patterned through photolithography and etching processes to form a mask, which is then used to etch and pattern dummy gate layer 238, and possibly the dummy dielectric layer 236. The remaining portions of mask layer 240, dummy gate layer 238, and dummy dielectric layer 236 form dummy gate stacks 242.

In FIG. 6B, gate spacers 244 and source/drain recesses 246. FIG. 6B is a cross-sectional view taken along line A-A of FIG. 5. First, the gate spacers 244 are formed over the multi-layer stacks 22 and on exposed sidewalls of dummy gate stacks 242. The gate spacers 244 may be formed by conformally forming one or more dielectric layers and subsequently etching the dielectric layers anisotropically. The applicable dielectric materials may include silicon oxide, silicon nitride, silicon oxynitride, silicon oxycarbonitride, or the like, which may be formed by a deposition process such as CVD, ALD, or the like.

Subsequently, source/drain recesses 246 are formed in semiconductor strips 228. The source/drain recesses 246 are formed through etching, and may extend through the multi-layer stacks 22 and into the semiconductor strips 220′. The bottom surfaces of the source/drain recesses 246 may be at a level above, below, or level with the top surfaces of the isolation regions 232. In the etching processes, the gate spacers 244 and the dummy gate stacks 242 mask some portions of the semiconductor strips 228. The etching may include a single etch process or multiple etch processes. Timed etch processes may be used to stop the etching of the source/drain recesses 246 upon source/drain recesses 246 reaching a desired depth.

In FIG. 6C, inner spacers 254 and dielectric isolation layers 256 are formed. Forming inner spacers 254 and dielectric isolation layers 256 may include an etching process that laterally etches the dummy nanostructures 224A and removes the dummy nanostructure 224B. The etching process may be isotropic and may be selective to the material of the dummy nanostructures 224, so that the dummy nanostructures 224 are etched at a faster rate than the semiconductor nanostructures 226. The etching process may also be selective to the material of the dummy nanostructures 224B, so that the dummy nanostructures 224B are etched at a faster rate than the dummy nanostructures 224A. In this manner, the dummy nanostructures 224B may be completely removed from between the lower semiconductor nanostructures 226L (collectively) and the upper semiconductor nanostructures 226U (collectively) without completely removing the dummy nanostructures 224A. In some embodiments where the dummy nanostructures 224B are formed of germanium or silicon germanium with a high germanium atomic percentage, the dummy nanostructures 224A are formed of silicon germanium with a low germanium atomic percentage, and the semiconductor nanostructures 226 are formed of silicon free from germanium, the etch process may comprise a dry etch process using chlorine gas, with or without a plasma. Because the dummy gate stacks 242 wrap around sidewalls of the semiconductor nanostructures 226 (see FIG. 6A), the dummy gate stacks 242 may support the upper semiconductor nanostructures 226U so that the upper semiconductor nanostructures 226U do not collapse upon removal of the dummy nanostructures 224B. Further, although sidewalls of the dummy nanostructures 224A are illustrated as being straight after the etching, the sidewalls may be concave or convex.

Inner spacers 254 are formed on sidewalls of the recessed dummy nanostructures 224A, and dielectric isolation layers 256 are formed between the upper semiconductor nanostructures 226U (collectively) and the lower semiconductor nanostructures 226L (collectively). As subsequently described in greater detail, source/drain regions will be subsequently formed in the source/drain recesses 246, and the dummy nanostructures 224A will be replaced with corresponding gate structures. The inner spacers 254 act as isolation features between the subsequently formed source/drain regions and the subsequently formed gate structures. Further, the inner spacers 254 may be used to prevent damage to the subsequently formed source/drain regions by subsequent etch processes, such as the etch processes used to form gate structures. Dielectric isolation layers 256, on the other hand, are used to isolate the upper semiconductor nanostructures 226U (collectively) from the lower semiconductor nanostructures 226L (collectively). Further, middle semiconductor nanostructures (ones of the semiconductor nanostructures 226 in contact with the dielectric isolation layers 256) and the dielectric isolation layers 256 may define the boundaries of the lower nanostructure-FETs and the upper nanostructure-FETs.

The inner spacers 254 and the dielectric isolation layers 256 may be formed by conformally depositing an insulating material in the source/drain recesses 246, on sidewalls of the dummy nanostructures 256A, and between the upper and lower semiconductor nanostructures 226U and 226L, and then etching the insulating material. The insulating material may be a non-low-k dielectric material, which may be a carbon-containing dielectric material such as silicon oxycarbonitride, silicon oxycarbide, silicon oxynitride, or the like. The insulating material may be formed by a deposition process, such as ALD, CVD, or the like. The etching of the insulating material may be anisotropic or isotropic. The insulating material, when etched, has portions remaining in the sidewalls of the dummy nanostructures 226A (thus forming the inner spacers 254) and has portions remaining in between the upper and lower semiconductor nanostructures 226U and 226L (thus forming the dielectric isolation layers 256).

As also illustrated by FIG. 6C, lower and upper epitaxial source/drain regions 262L and 262U are formed. The lower epitaxial source/drain regions 262L are formed in the lower portions of the source/drain recesses 246. The lower epitaxial source/drain regions 262L are in contact with the lower semiconductor nanostructures 226L and are not in contact with the upper semiconductor nanostructures 226U. Inner spacers 254 electrically insulate the lower epitaxial source/drain regions 262L from the dummy nanostructures 224A, which will be replaced with replacement gates in subsequent processes.

The lower epitaxial source/drain regions 262L are epitaxially grown, and have a conductivity type that is suitable for the device type (p-type or n-type) of the lower nanostructure-FETs. When lower epitaxial source/drain regions 262L are n-type source/drain regions, the respective material may include silicon or carbon-doped silicon, which is doped with an n-type dopant such as phosphorous, arsenic, or the like. When lower epitaxial source/drain regions 262L are p-type source/drain regions, the respective material may include silicon or silicon germanium, which is doped with a p-type dopant such as boron, indium, or the like. The lower epitaxial source/drain regions 262L may be in-situ doped, and may be, or may not be, implanted with the corresponding p-type or n-type dopants. During the epitaxy of the lower epitaxial source/drain regions 262L, the upper semiconductor nanostructures 226U may be masked to prevent undesired epitaxial growth on the upper semiconductor nanostructures 226U. After the lower epitaxial source/drain regions 262L are grown, the masks on the upper semiconductor nanostructures 226U may then be removed.

As a result of the epitaxy processes used for forming the lower epitaxial source/drain regions 262L, upper surfaces of the lower epitaxial source/drain regions 262L have facets which expand laterally outward beyond sidewalls of the multi-layer stacks 22. In some embodiments, adjacent lower epitaxial source/drain regions 262L remain separated after the epitaxy process is completed. In other embodiments, these facets cause neighboring lower epitaxial source/drain regions 262L of a same FET to merge.

A first contact etch stop layer (CESL) 266 and a first ILD 268 are formed over the lower epitaxial source/drain regions 262L. The first CESL 266 may be formed of a dielectric material having a high etching selectivity from the etching of the first ILD 268, such as silicon nitride, silicon oxide, silicon oxynitride, or the like, which may be formed by any suitable deposition process, such as CVD, ALD, or the like. The first ILD 268 may be formed of a dielectric material, which may be deposited by any suitable method, such as CVD, plasma-enhanced CVD (PECVD), or FCVD. The applicable dielectric material of the first ILD 268 may include phospho-silicate glass (PSG), boro-silicate glass (BSG), boron-doped phospho-silicate glass (BPSG), undoped silicate glass (USG), silicon oxide, or the like.

The formation processes may include depositing a conformal CESL layer, depositing a material for the first ILD 268, followed by a planarization process and then an etch-back process. In some embodiments, the first ILD 268 is etched first, leaving the first CESL 266 unetched. An anisotropic etching process is then performed to remove the portions of the first CESL 266 higher than the recessed first ILD 268. After the recessing, the sidewalls of the upper semiconductor nanostructures 226U are exposed.

Upper epitaxial source/drain regions 262U are then formed in the upper portions of the source/drain recesses 246. The upper epitaxial source/drain regions 262U may be epitaxially grown from exposed surfaces of the upper semiconductor nanostructures 226U. The materials of upper epitaxial source/drain regions 262U may be selected from the same candidate group of materials for forming lower source/drain regions 262L, depending on the desired conductivity type of upper epitaxial source/drain regions 262U. The conductivity type of the upper epitaxial source/drain regions 262U may be opposite the conductivity type of the lower epitaxial source/drain regions 262L. For example, the upper epitaxial source/drain regions 262U may be oppositely doped from the lower epitaxial source/drain regions 262L. The upper epitaxial source/drain regions 262U may be in-situ doped, and/or may be implanted, with an n-type or p-type dopant. Adjacent upper source/drain regions 262U may remain separated after the epitaxy process or may be merged.

After the epitaxial source/drain regions 262U are formed, a second CESL 270 and a second ILD 272 are formed. The materials and the formation methods may be similar to the materials and the formation methods of first CESL 266 and first ILD 268, respectively, and are not discussed in detail herein. The formation process may include depositing the layers for CESL 270 and ILD 272, and performing a planarization process to remove the excess portion of the corresponding layers. After the planarization process, top surfaces of the second ILD 272, the gate spacers 244, and the dummy gate stacks 242 are coplanar (within process variations). The planarization process may remove masks 240, or leave hard masks 240 unremoved.

FIGS. 6D and 6E illustrate a replacement gate process to replace the dummy gate stacks 242 and the dummy nanostructures 224A with gate stacks 290. The replacement gate process includes first removing the dummy gate stacks 242 and the remaining portions of the dummy nanostructures 224A. The dummy gate stacks 242 are removed in one or more etching processes, so that recesses are defined between the gate spacers 244 and the upper portions of the semiconductor strips 228 are exposed. The remaining portions of the dummy nanostructures 224A are then removed through etching, so that the recesses extend between the semiconductor nanostructures 226. In the etching process, the dummy nanostructures 224A is etched at a faster rate than the semiconductor nanostructures 226, the dielectric isolation layers 256, and the inner spacers 254. The etching may be isotropic. For example, when the dummy nanostructures 224A are formed of silicon-germanium, and the semiconductor nanostructures 226 are formed of silicon, the etch process may include a wet etch process using tetramethylammonium hydroxide (TMAH), ammonium hydroxide (NH₄OH), or the like.

Then, gate dielectrics 278 are deposited in the recesses between the gate spacers 244 and on the exposed semiconductor nanostructures 226. The gate dielectrics 278 are conformally formed on the exposed surfaces of the recesses (the removed gate stacks 242 and the dummy nanostructures 224A) including the semiconductor nanostructures 226 and the gate spacers 244. In some embodiments, the gate dielectrics 278 wrap around all (e.g., four) sides of the semiconductor nanostructures 226. Specifically, the gate dielectrics 278 may be formed on the top surfaces of the fins 220′; on the top surfaces, the sidewalls, and the bottom surfaces of the semiconductor nanostructures 226; and on the sidewalls of the gate spacers 244. The gate dielectrics 278 may include an oxide such as silicon oxide or a metal oxide, a silicate such as a metal silicate, combinations thereof, multi-layers thereof, or the like. The gate dielectrics 278 may include a high-dielectric constant (high-k) material having a k-value greater than about 7.0, such as a metal oxide or a silicate of hafnium, aluminum, zirconium, lanthanum, manganese, barium, titanium, lead, and combinations thereof. The formation methods of the gate dielectrics 278 may include molecular-beam deposition (MBD), ALD, PECVD, and the like followed by a planarization process (e.g., a CMP) to remove portions of the gate dielectrics 278 above the second ILD 272. Although single-layered gate dielectrics 278 are illustrated, the gate dielectrics 278 may include multiple layers, such as an interfacial layer and an overlying high-k dielectric layer.

As illustrated in FIG. 6D, lower gate electrodes 280L are formed on the gate dielectrics 278 around the lower semiconductor nanostructures 226L and the upper semiconductor nanostructures 226U. For example, the lower gate electrodes 280L wrap around the lower semiconductor nanostructures 226L and the upper semiconductor nanostructures 226U at this point before they will be removed from the upper semiconductor nanostructures 226U. The lower gate electrodes 280L may be formed of a metal-containing material such as tungsten, titanium, titanium nitride, tantalum, tantalum nitride, tantalum carbide, aluminum, ruthenium, cobalt, combinations thereof, multi-layers thereof, or the like. Although single-layered gate electrodes are illustrated, the lower gate electrodes 280L may include any number of work function tuning layers, any number of barrier layers, any number of glue layers, and a fill material.

The lower gate electrodes 280L are formed of material(s) that are suitable for the device type of the lower nanostructure-FETs. For example, the lower gate electrodes 280L may include one or more work function tuning layer(s) formed of material(s) that are suitable for the device type of the lower nanostructure-FETs. In some embodiments, the lower gate electrodes 280L include an n-type work function tuning layer, which may be formed of titanium aluminum, titanium aluminum carbide, tantalum aluminum, tantalum carbide, combinations thereof, or the like. In some embodiments, the lower gate electrodes 280L include a p-type work function tuning layer, which may be formed of titanium nitride, tantalum nitride, combinations thereof, or the like. Additionally or alternatively, the lower gate electrodes 280L may include a dipole-inducing element that is suitable for the device type of the lower nanostructure-FETs. Acceptable dipole-inducing elements include lanthanum, aluminum, scandium, ruthenium, zirconium, erbium, magnesium, strontium, and combinations thereof.

The lower gate electrodes 280L may be formed by conformally depositing one or more gate electrode layer(s) followed by a process of planarizing and recessing the gate electrode layer(s). After the planarization process, the lower gate electrodes 280L may be recessed to around the level of the isolation layer 256. The recessing process may include any acceptable etch process, such as a dry etch, a wet etch, the like, or a combination thereof, may be performed to recess the gate electrode layer(s). The etching may be isotropic. Etching the lower gate electrodes 280L may expose the upper semiconductor nanostructures 226U.

In some embodiments, isolation layers (not explicitly illustrated) may be optionally formed on the lower gate electrodes 280L. The isolation layers act as isolation features between the lower gate electrodes 280L and subsequently formed upper gate electrodes 280U. The isolation layers may be formed by conformally depositing a dielectric material (e.g., silicon oxide, silicon nitride, silicon oxynitride, silicon oxycarbonitride, combinations thereof, or the like) and subsequently recessing the dielectric material to expose the upper semiconductor nanostructures 226U.

In FIG. 6D, the replacement gate process involves etching away dummy nanostructures 224A and subsequently depositing high-k gate dielectrics 278 and lower gate electrodes 280L using metal-containing materials such as hafnium oxide, titanium nitride, or tungsten. These processes generate metal-containing wastewater streams that include dissolved metal ions, depending on the materials used. The metal-containing waste solution produced during these steps can be effectively treated using the FBHC system 110 as described in FIGS. 2A-3B. By employing the FBHC system 110, the FBHC system 110 can induce the controlled crystallization of these dissolved metal ions under optimized pH and flow conditions, leading to the formation of solid metal-based crystalline particles that settle out of solution. This not only can reduce the concentration of residual metal ions in the effluent but also minimize sludge volume and allow for the potential recovery of valuable metals.

In FIG. 6E, upper gate electrodes 280U are formed on the isolation layers described above (if present) or the lower gate electrodes 280L. The upper gate electrodes 280U are disposed between the upper semiconductor nanostructures 226U. In some embodiments, the upper gate electrodes 280U wrap around the upper semiconductor nanostructures 226U. The upper gate electrodes 280U may be formed of the same candidate materials and candidate processes for forming the lower gate electrodes 280L. The upper gate electrodes 280U are formed of material(s) that are suitable for the device type of the upper nanostructure-FETs. For example, the upper gate electrodes 280U may include one or more work function tuning layer(s) formed of material(s) that are suitable for the device type of the upper nanostructure-FETs. Although single-layered gate electrodes 280U are illustrated, the upper gate electrodes 280U may include any number of work function tuning layers, any number of barrier layers, any number of glue layers, and a fill material.

Additionally, a removal process is performed level top surfaces of the upper gate electrodes 280U and the second ILD 272. The removal process for forming the gate dielectrics 278 may be the same removal process as the removal process for forming the upper gate electrodes 280U. In some embodiments, a planarization process such as a CMP, an etch-back process, combinations thereof, or the like may be utilized. After the planarization process, the top surfaces of the upper gate electrodes 280U, the gate dielectrics 278, the second ILD 272, and the gate spacers 244 are substantially coplanar (within process variations). Each respective pair of a gate dielectric 278 and a gate electrode 280 (including an upper gate electrode 280U and/or a lower gate electrode 280L) may be collectively referred to as a “gate structure” 290 (including upper gate structures 290U and lower gate structures 290L). Each gate structure 290 extends along three sides (e.g., a top surface, a sidewall, and a bottom surface) of a channel region of a semiconductor nanostructure 226 (see FIG. 5). The lower gate structures 290L may also extend along sidewalls and/or a top surface of a semiconductor fin 220′.

As also shown in FIG. 6E, gate masks 292 are formed over the gate stacks 242. The formation process may include recessing gate stacks 290, filling the resulting recesses with a dielectric material such as silicon nitride, silicon carbonitride, silicon oxynitride, silicon oxycarbonitride, or the like, and performing a planarization process to remove the excess portions of the dielectric material over the second ILD 272.

In FIG. 6F, silicide regions 294 and source/drain contact plugs 296U are formed through the second ILD 272 to electrically couple to the upper epitaxial source/drain regions 262U and/or the lower epitaxial source/drain regions 262L. An etch stop layer (ESL) 304 and a third ILD 306 are the formed. In some embodiments, The ESL 304 may include a dielectric material having a high etching selectivity from the etching of the third ILD 306, such as, aluminum oxide, aluminum nitride, silicon oxycarbide, or the like. The third ILD 306 may be formed using flowable CVD, ALD, or the like, and the material may include PSG, BSG, BPSG, USG, or the like, which may be deposited by any suitable method, such as CVD, PECVD, or the like.

Subsequently, upper gate contact plugs 308 and source/drain contact plugs 310 are formed to contact the upper gate electrodes 280U and the upper source/drain contact plugs 296U, respectively. The active devices as illustrated are collectively referred to as a device layer 312.

A front-side interconnect structure 314 is formed on the device layer 312. The front-side interconnect structure 314 includes dielectric layers 316 and layers of conductive features 318/320 in the dielectric layers 316. The dielectric layers 316 may include low-k dielectric layers formed of low-k dielectric materials. The dielectric layers 316 may further include passivation layers, which are formed of non-low-k and dense dielectric materials such as Undoped Silicate-Glass (USG), silicon oxide, silicon nitride, or the like, or combinations thereof over the low-k dielectric materials. The dielectric layers 316 may also include polymer layers.

The conductive features 318/320 may include conductive lines 318 and vias 320, which may be formed using damascene processes. Conductive features 318/320 may include metal lines 318 and metal vias 320, which includes diffusion barriers and a copper containing material over the diffusion barriers. There may also be aluminum pads over and electrically connected to the metal lines and vias. Depending on how the respective die is to be packaged, the top surface features among the conductive features 318 may include bond pads, metal pillars, solder regions, and/or the like.

In some embodiments, a backside interconnect structure may be formed. The backside interconnect structure may provide electrical connection with the lower gate stacks 290L and the lower source/drain regions 280L through a backside of the device layer 312 (e.g., a side opposite to the front-side interconnect structure 314). The backside interconnect structure may be similar to the front-side interconnect structure 314 described above the description is not repeated herein. In some embodiments, the connection to the lower gate stacks 290L and the lower source/drain regions 280L be made by contacts (sometimes referred to as contact plugs) and the backside interconnect structure may be omitted.

In FIG. 6F, the formation of silicide regions 294, metal contact plugs 296U/310, and the front-side interconnect structure 314 can include the use of metal-containing materials such as cobalt, nickel, tungsten, copper, or titanium. These processes may generate wastewater containing metal ions, etchants, and chemical residues. Such metal-containing waste solution can be effectively treated using the FBHC technology described in FIGS. 2A-3B, which can facilitate the crystallization and removal of dissolved metal ions under controlled pH and flow conditions, reducing environmental impact and enabling resource recovery.

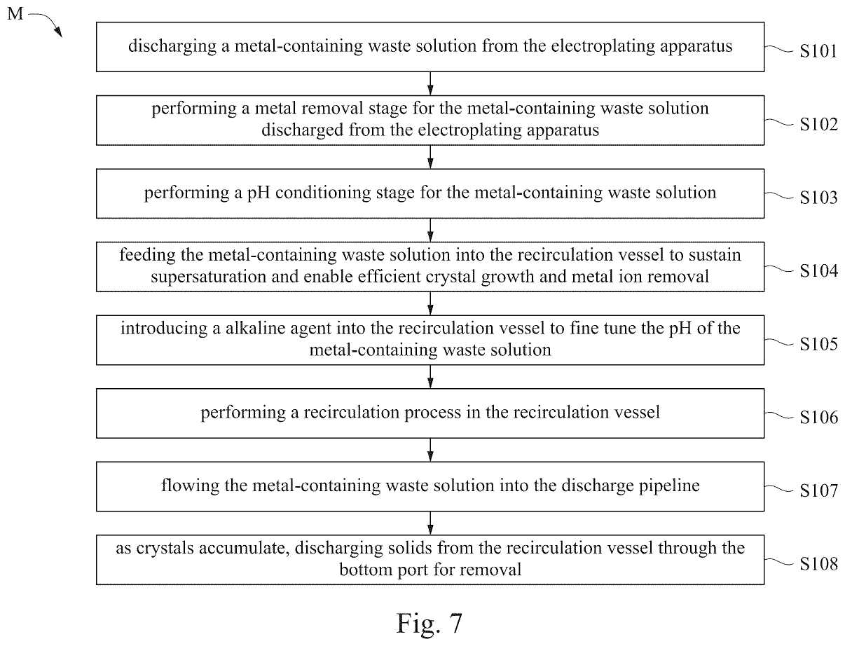

Reference is made to FIG. 7. FIG. 7 is a flowchart of a method M of processing metal-containing waste solutions as illustrated in FIGS. 1A-3B, in accordance with some embodiments of the present disclosure. The described method M outlines steps for the movement process. It is to be understood that additional operations may be performed before, during, or after the steps shown in FIG. 7, and that some of the described steps may be replaced or omitted in other embodiments. Furthermore, the order of these operations or processes may be interchangeable, providing flexibility depending on specific requirements.

The method M begins at step S101, where a metal-containing waste solution is discharged from the electroplating apparatus. Specifically, the step S101 can involve the apparatus (e.g., electroplating apparatus 10, where metal ions, such as Cu²⁺ in an aqueous electrolyte can be deposited onto a target substrate through an electrochemical reduction reaction. The apparatus can include a plating tank, electrodes (with the substrate as the cathode), and a power supply that drives the plating process. The metal-containing waste solution can be discharged from the fabrication system 15 (e.g., electroplating apparatus 10) after prolonged use, as the electrolyte, originally used to deposit metal ions like Cu²⁺ onto a target substrate via electrochemical reduction, gradually degrades due to side reactions and impurity buildup, making it unsuitable for continued plating operations and requiring removal as wastewater.

The method M proceeds to step S102, where a metal removal stage is performed for the metal-containing waste solution discharged from the electroplating apparatus. Once the plating solution (e.g., metal-containing waste solution) reaches the end of its useful life, it is collected and discharged through the electroplating system 100. The electroplating system 100 can serve as an initial metal removal stage for the metal-containing waste solution discharged from the fabrication system 15 (e.g., electroplating apparatus 10). Its main function is to perform an electrochemical reduction process, where residual metal ions (such as Cu²⁺) in the waste electrolyte can be reduced and deposited onto a cathode. This decreases the metal ion concentration in the solution, to around 300-500 ppm. To further enhance plating uniformity and efficiency, optional leveling agents, organic or inorganic, can be added. These agents help suppress uneven deposition, improve layer smoothness, and promote complete ion reduction, resulting in more efficient copper removal.

The method M proceeds to step S103, where a pH conditioning stage is performed for the metal-containing waste solution. The metal-containing waste solution can enter the waste liquid buffer tank 111. This tank may act as a temporary reservoir to stabilize the volume and composition of incoming wastewater. It helps balance fluctuations in flow rate, temperature, or metal ion concentration before further chemical processing. In some embodiments, the buffer tank 111 can function as the initial pH conditioning stage in the FBHC system 110. The buffer tank 111 can receive the acidic metal-containing waste solution and mixes it with a first strong alkaline agent, such as sodium hydroxide (NaOH), to partially neutralize the solution. Through this acid-base reaction, hydrogen ions (H⁺) in the waste react with hydroxide ions (OH⁻) to form water, gradually raising the pH from around 1 to a moderately acidic range of approximately 3-4. This step can stabilize the solution chemically, making it more suitable for the subsequent crystallization process in the recirculation vessel 112a. The buffer tank 111 can prepare the waste stream for efficient metal ion removal by ensuring appropriate chemical conditions before fine pH adjustment and crystallization occur downstream.

The method M proceeds to step S104, where the metal-containing waste solution is fed into a recirculation vessel to sustain supersaturation and enable efficient crystal growth and metal ion removal. After pH adjustment to approximately 3-4 in the buffer tank 111, the pretreated metal-containing waste solution can enter the vessel through inlet 112b. In some embodiments, the metal-containing waste solution enters the recirculation vessel 112a from buffer tank 111 at a continuous inlet flow rate of approximately 2-20 mL/min, such as approximately 2, 3, 4, 5, 6, 7, 8, 9, 10, 11, 12, 13, 14, 15, 16, 17, 18, 19, or 20 mL/min, while approximately 1-2 mL/min of treated liquid is discharged. This flow rate difference may help establish a stable fluidized bed, where excess liquid recirculates internally to sustain optimal fluid motion. This continuous flow setup can enables the FBHC system 110 to maintain supersaturation conditions that favor uniform metal crystal nucleation and growth, supporting efficient, low-fouling, and scalable removal of dissolved metal ions.

The method M proceeds to step S105, where a alkaline agent is introduced into the recirculation vessel to fine tune the pH of the metal-containing waste solution. Within this recirculation vessel 112a, a fluidized bed environment can be maintained to promote particle growth and crystallization. A second, weaker alkaline agent such as sodium carbonate is introduced through inlet 112d to finely tune the pH to around 6.5, optimizing crystallization conditions.

The method M proceeds to step S106, a recirculation process is performed in the recirculation vessel. The recirculation process is performed in the recirculation vessel 112a to enhance metal ion crystallization by creating a stable fluidized bed through vertically oriented flow. A portion of the fluid is continuously drawn from the top via recirculation outlet 112e and reintroduced near the bottom through inlet 112c. This setup can maintain upward fluid motion that keeps fine particles suspended for extended periods, increasing their chances to grow into larger crystals. Meanwhile, heavier crystals settle at the bottom for eventual collection. The vertical flow also allows for natural particle stratification and minimizes turbulence near the inlets, protecting crystal formation. In some embodiments, the metal-containing waste solution enters the recirculation vessel 112a while, at the same time, a second, weaker alkaline agent such as sodium carbonate is introduced through inlet 112d to further adjust the pH. Simultaneously, the recirculation process can circulates fluid from the bottom to the top of the vessel, promoting uniform mixing, stable fluidized bed formation, and efficient metal ion crystallization.

The method M proceeds to step S107, where the metal-containing waste solution flows into the discharge pipeline. After the metal-containing waste solution completes its treatment in the wastewater treatment system 120, it flows into the discharge pipeline 130, where it is transported out of the facility for final handling, either released into a permitted drainage system or directed to a centralized treatment plant, depending on site-specific and regulatory conditions.

The method M proceeds to step S108, where as crystals accumulate, solids from the recirculation vessel is discharged. as crystallization proceeds in the recirculation vessel 112a, larger and denser metal-based crystals gradually settle at the bottom due to gravity. Once a sufficient quantity has accumulated, such as exceeding half the vessel height, the FBHC system 110 may pause or adjust recirculation to allow removal. At that point, the settled crystals can be discharged through the crystal discharge port 112i near the vessel base, enabling efficient extraction of well-formed, low-moisture crystals without significantly disrupting ongoing treatment processes.

Therefore, based on the above discussions, it can be seen that the present disclosure offers advantages. It is understood, however, that other embodiments may offer additional advantages, and not all advantages are necessarily disclosed herein, and that no particular advantage is required for all embodiments. The present disclosure in various embodiments provides a fluidized bed homogeneous crystallization (FBHC) technology, which continuously treats metal-containing (e.g., copper-containing) waste solution by inducing the controlled nucleation and growth of metal-based (e.g., copper-based) crystals within a fluidized environment. The FBHC technique can allow fine-tuned pH control and supersaturation management, enabling metal ions like Cu²⁺ to crystallize as high-purity, low-moisture solids that can be collected and reused. The FBHC technique can minimize sludge generation, reduce the need for chelating agents, and improve the recovery rate of copper in a reusable form. Additionally, the continuous-flow operation can enhances treatment efficiency, scalability, and environmental compliance, making it suitable for integration into high-throughput industrial systems.

In some embodiments, a method includes providing an aqueous solution comprising one or more dissolved metal ions; partially neutralizing the aqueous solution by adding a first alkaline agent to adjust a pH of the aqueous solution toward a first target range; after partially neutralizing the aqueous solution, introducing the aqueous solution into a crystallization chamber; introducing a second alkaline agent into the crystallization chamber; recirculating the aqueous solution within the crystallization chamber; inducing a crystallization of metal-based solids from the aqueous solution within the crystallization chamber.

In some embodiments, the aqueous solution comprises copper ions. In some embodiments, the second alkaline agent has a lower basicity than the first alkaline agent. In some embodiments, adjusting the pH of the aqueous solution comprises increasing the pH from below about 3.0 to the first target range that is between about 3.0 and 5.0. In some embodiments, the second alkaline agent adjusts the pH of the aqueous solution within the crystallization chamber to a second target range between 6.0 and 7.0. In some embodiments, recirculating the aqueous solution is performed at a flow rate between about 2 and 20 mL/min. In some embodiments, recirculating the aqueous solution comprises drawing liquid from a top portion of the crystallization chamber and reintroducing the liquid at a bottom portion of the crystallization chamber. In some embodiments, the metal-based solids comprise copper sulfate or hydrated copper sulfate. In some embodiments, the method further includes heating the aqueous solution before or during introducing the aqueous solution into the crystallization chamber. In some embodiments, the method further includes discharging the crystallization of the metal-based solids from the crystallization chamber.

In some embodiments, a method includes introducing a metal-containing aqueous solution into a vertically oriented fluidized crystallization reactor; adding an alkaline agent into the vertically oriented fluidized crystallization reactor to adjust a pH of the metal-containing aqueous solution and induce a crystallization of metal-based solids from the metal-containing aqueous solution; maintaining an upward flow within the vertically oriented fluidized crystallization reactor; removing a crystallization of metal-based solids from the vertically oriented fluidized crystallization reactor upon reaching a target accumulation threshold. In some embodiments, the alkaline agent comprises sodium carbonate. In some embodiments, the method further includes measuring the pH in real time to control dosing of the alkaline agent. In some embodiments, the method further includes recirculating a portion of the metal-containing aqueous solution within the vertically oriented fluidized crystallization reactor to promote supersaturation stability and crystal growth. In some embodiments, the metal-containing aqueous solution is derived from a semiconductor manufacturing electroplating process.

In some embodiments, a system includes a pH adjustment module and a crystallization reactor. The pH adjustment module is configured to partially neutralize a metal-containing aqueous solution by introducing a first alkaline agent. The crystallization reactor includes a vertically oriented fluidized chamber, a first inlet, a second inlet, a recirculation loop, and a discharge port. The first inlet is positioned near a lower portion of the vertically oriented fluidized chamber and is configured to introduce the partially neutralized metal-containing aqueous solution. The second inlet is configured to deliver a second alkaline agent into the vertically oriented fluidized chamber. The recirculation loop is configured to withdraw the metal-containing aqueous solution from an upper portion of the vertically oriented fluidized chamber and reintroduce the metal-containing aqueous solution into the lower portion of the vertically oriented fluidized chamber to maintain an upward fluid flow. The discharge port is disposed near the lower portion of the vertically oriented fluidized chamber for removing metal-based crystalline solids from the metal-containing aqueous solution.

In some embodiments, the system further includes an electroplating apparatus, wherein the electroplating apparatus is operatively connected to the pH adjustment module and is configured to supply the metal-containing aqueous solution directly to the pH adjustment module. In some embodiments, the first and second inlets are co-located at substantially the same vertical elevation. In some embodiments, the crystallization reactor further comprises a treated solution outlet positioned above a recirculation outlet at the upper portion of the vertically oriented fluidized chamber. In some embodiments, the vertically oriented fluidized chamber comprises at least two sampling ports located at different vertical positions for monitoring metal ion concentration gradients in the metal-containing aqueous solution.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
providing an aqueous solution comprising one or more dissolved metal ions;
partially neutralizing the aqueous solution by adding a first alkaline agent to adjust a pH of the aqueous solution toward a first target range;
after partially neutralizing the aqueous solution, introducing the aqueous solution into a crystallization chamber;
introducing a second alkaline agent into the crystallization chamber;
recirculating the aqueous solution within the crystallization chamber; and
inducing a crystallization of metal-based solids from the aqueous solution within the crystallization chamber.

2. The method of claim 1, wherein the aqueous solution comprises copper ions.

3. The method of claim 1, wherein the second alkaline agent has a lower basicity than the first alkaline agent.

4. The method of claim 1, wherein adjusting the pH of the aqueous solution comprises increasing the pH from below about 3.0 to the first target range that is between about 3.0 and 5.0.

5. The method of claim 1, wherein the second alkaline agent adjusts the pH of the aqueous solution within the crystallization chamber to a second target range between about 6.0 and 7.0.

6. The method of claim 1, wherein recirculating the aqueous solution is performed at a flow rate between about 20 and 140 mL/min.

7. The method of claim 1, wherein recirculating the aqueous solution comprises drawing liquid from a top portion of the crystallization chamber and reintroducing the liquid at a bottom portion of the crystallization chamber.

8. The method of claim 1, wherein the metal-based solids comprise copper sulfate or hydrated copper sulfate.

9. The method of claim 1, further comprising:
heating the aqueous solution before or during introducing the aqueous solution into the crystallization chamber.

10. The method of claim 1, further comprising:
discharging the crystallization of the metal-based solids from the crystallization chamber.

11. A method, comprising:
introducing a metal-containing aqueous solution into a vertically oriented fluidized crystallization reactor;
adding an alkaline agent into the vertically oriented fluidized crystallization reactor to adjust a pH of the metal-containing aqueous solution and induce a crystallization of metal-based solids from the metal-containing aqueous solution;
maintaining an upward flow within the vertically oriented fluidized crystallization reactor; and
removing a crystallization of metal-based solids from the vertically oriented fluidized crystallization reactor upon reaching a target accumulation threshold.

12. The method of claim 11, wherein the alkaline agent comprises sodium carbonate.

13. The method of claim 11, further comprising:
measuring the pH in real time to control dosing of the alkaline agent.

14. The method of claim 11, further comprising:
recirculating a portion of the metal-containing aqueous solution within the vertically oriented fluidized crystallization reactor to promote supersaturation stability and crystal growth.

15. The method of claim 11, wherein the metal-containing aqueous solution is derived from a semiconductor manufacturing electroplating process.

16. A system, comprising:
a pH adjustment module configured to partially neutralize a metal-containing aqueous solution by introducing a first alkaline agent; and
a crystallization reactor comprising:
a vertically oriented fluidized chamber;
a first inlet positioned near a lower portion of the vertically oriented fluidized chamber and configured to introduce the partially neutralized metal-containing aqueous solution;
a second inlet configured to deliver a second alkaline agent into the vertically oriented fluidized chamber;
a recirculation loop configured to withdraw the metal-containing aqueous solution from an upper portion of the vertically oriented fluidized chamber and reintroduce the metal-containing aqueous solution into the lower portion of the vertically oriented fluidized chamber to maintain an upward fluid flow; and
a discharge port disposed near the lower portion of the vertically oriented fluidized chamber for removing metal-based crystalline solids from the metal-containing aqueous solution.

17. The system of claim 16, further comprising:
an electroplating apparatus, wherein the electroplating apparatus is operatively connected to the pH adjustment module and is configured to supply the metal-containing aqueous solution directly to the pH adjustment module.

18. The system of claim 16, wherein the first and second inlets are co-located at substantially the same vertical elevation.

19. The system of claim 16, wherein the crystallization reactor further comprises a treated solution outlet positioned above a recirculation outlet at the upper portion of the vertically oriented fluidized chamber.

20. The system of claim 16, wherein the vertically oriented fluidized chamber comprises at least two sampling ports located at different vertical positions for monitoring metal ion concentration gradients in the metal-containing aqueous solution.
